(19) United States
(12) Patent Application Publication
(10) Pub. No.: US 2021/0400908 A1
(43) Pub. Date: Dec. 30, 2021

(54) METHOD, SYSTEM AND APPARATUS FOR GRAZING LIVESTOCK AND FARMING ROW CROPS IN A FIELD

(71) Applicant: STOCK CROPPER, INC., Leland, IA (US)

(72) Inventors: Zachary John Smith, Leland, IA (US); Sheldon William Stevermer, Easton, MN (US); Lance Ryan Petersen, Rush City, MN (US)

(21) Appl. No.: 17/355,476

(22) Filed: Jun. 23, 2021

Related U.S. Application Data
(60) Provisional application No. 63/044,132, filed on Jun. 25, 2020.

(51) Int. Cl. A01K 3/00; A01K 1/00; B60B 33/06; B60L 50/60; B60L 8/00; B60Q 9/00

(52) U.S. Cl. CPC A01K 3/001; A01K 1/0035; B60B 33/066; B60L 2200/36; B60L 8/003; B60Q 9/00; B60L 50/60

(57) ABSTRACT

In one or more arrangements, a portable livestock enclosure system is provided to facilitate stock cropping of a field. The system includes a mobile enclosure and one or more enclosed grazing areas. The one or more enclosed grazing areas are operably connected to the mobile enclosure. The mobile enclosure also includes a set of lift wheel assemblies configured to move a set of wheels between a retracted position and an extended position. The mobile enclosure and one or more enclosed grazing areas are lifted off of the ground to facilitate movement of the portable livestock enclosure system when set of wheels are moved to the extended position. The mobile enclosure and one or more enclosed grazing areas are placed on or near the ground when the set of wheels are moved to the retracted position.

### PRIOR RELATED APPLICATIONS

This application claims priority to U.S. Provisional Patent Application No. 63/044,132 filed Jun. 25, 2020, and titled “METHOD, SYSTEM AND APPARATUS FOR GRAZING LIVESTOCK AND FARMING ROW CROPS IN A FIELD”, which is hereby fully incorporated by reference herein.

### FIELD OF THE DISCLOSURE

This disclosure relates generally to farming and livestock husbandry. More specifically, and without limitation, this disclosure relates generally to a system and method for grazing livestock and farming row crops in a field.

### OVERVIEW OF THE DISCLOSURE

Modern agriculture relies on extensive use of fertilizers to maintain high production yields. As an alternative or supplement to fertilization, plant growth may be improved through crop rotation or intercropping with other row crops, cover crops, and/or forage crops to improve various characteristic of the soil (e.g., chemistry and nutrients, porosity, and/or biodiversity). Typically, crops are rotated for an entire field from one season to the next. However, while it may be beneficial to soil characteristics to plant non-cash crops, it may be prohibitively expensive or otherwise undesirable to omit planting of cash crops in an entire field for an entire season.

Thus, it is a primary object of the disclosure to provide a portable livestock enclosure system that improves upon the state of the art.

Another object of the disclosure is to provide a portable livestock enclosure system configured to facilitate grazing of livestock in a field.

Yet another object of the disclosure is to provide a portable livestock enclosure system configured to facilitate concurrent grazing of livestock and planting of row crops in a field.

Another object of the disclosure is to provide a portable livestock enclosure system configured to house multiple different types of animals.

Yet another object of the disclosure is to provide a portable livestock enclosure system configured to organically fertilize a field during use.

Another object of the disclosure is to provide a portable livestock enclosure system configured to improve planting yields.

Yet another object of the disclosure is to provide a portable livestock enclosure system configured to improve biodiversity.

Another object of the disclosure is to provide a portable livestock enclosure system configured to assist with manure management.

Yet another object of the disclosure is to provide a portable livestock enclosure system that is relatively inexpensive.

Another object of the disclosure is to provide a portable livestock enclosure system that is easy to deploy.

Yet another object of the disclosure is to provide a portable livestock enclosure system that is easy to move.

Another object of the disclosure is to provide a portable livestock enclosure system that is easy to transport between fields.

Yet another object of the disclosure is to provide a portable livestock enclosure system that can be transported on public roads.

Another object of the disclosure is to provide a portable livestock enclosure system that has a long useful life.

Yet another object of the disclosure is to provide a portable livestock enclosure system that is durable.

Another object of the disclosure is to provide a portable livestock enclosure system that has a robust design.

Yet another object of the disclosure is to provide a portable livestock enclosure system that is high quality.

Another object of the disclosure is to provide a portable livestock enclosure system that is easy to use.

Yet another object of the disclosure is to provide a portable livestock enclosure system that helps to reduce runoff from a field.

Another object of the disclosure is to provide a portable livestock enclosure system that is environmentally friendly.

Yet another object of the disclosure is to provide a portable livestock enclosure system that can be profitably operated.

Another object of the disclosure is to provide a portable livestock enclosure system that integrates well with modern farming practices.

Yet another object of the disclosure is to provide a portable livestock enclosure system that can be configured into endless configurations.

Another object of the disclosure is to provide a portable livestock enclosure system that can be used in association with multiple different crops.

Yet another object of the disclosure is to provide a portable livestock enclosure system that can be used in a wide variety geographies.

Another object of the disclosure is to provide a portable livestock enclosure system that can be used with a wide variety of farming practices.

Yet another object of the disclosure is to provide a portable livestock enclosure system that can be used with a wide variety of animal husbandry practices.

These and other objects, features, or advantages of the disclosure will become apparent from the specification, figures and claims.

### SUMMARY OF THE DISCLOSURE

A new agricultural production system and process referred to herein as stock cropping is disclosed. Stock cropping is an agricultural production system and process that integrates grazing and/or housing livestock on strips of forage crops that are interspaced with strips of row crops that are grown and cultivated simultaneously in a field at the same time. Stock Cropping involves strip intercropping methods where strips of row crops (such as corn, soybeans, wheat, barley, oats, rye grass) and are grown in widths (e.g., 15-40 ft, or any other width, dependent on species of crop) and interlaced with alternating strips of forage pasture where the livestock will be raised. Livestock will be raised in a portable livestock enclosure system that feeds, waters, and shelters livestock that is able to be advanced through said pasture strips on a calculated basis.

As described herein, stock cropping may utilize multiple species of livestock (e.g., monogastric, ruminant, and/or avian animals) in various sequential orders of progression through the pasture strip.

In one or more arrangements, a portable livestock enclosure system is provided to facilitate stock cropping of a field. The system includes a mobile enclosure (e.g., a barn or other shelter) and one or more enclosed grazing areas (e.g., pens). The mobile enclosure has a frame having a front end, a rear end, and opposing sides. The one or more enclosed grazing areas are operably connected to the frame of the mobile enclosure. The mobile enclosure also includes a set of lift wheel assemblies operably connected to the frame. The set of lift wheel assemblies are configured to move a set of wheels between a retracted position and an extended position. The mobile enclosure and one or more enclosed grazing areas are lifted off of the ground when set of wheels are moved to the extended position. The mobile enclosure and one or more enclosed grazing areas are placed on or near the ground when the set of wheels are moved to the retracted position.

In one or more arrangements, the portable livestock enclosure system is configured to house multiple different types of livestock at the same time. In one or more arrangements, the mobile enclosure is configured to be moved through strips of foraging crops in a field to facilitate grazing at least some of the livestock on the foraging crops and fertilizing the strips of foraging crops by depositing manure of the livestock onto the ground located underneath the portable livestock enclosure system.

In one or more arrangements a method for farming row crops and grazing livestock in a field is provided. Row crops are planted in a first plurality of strips in the field. Foraging crops in a second plurality of strips in the field. The first plurality of strips are separated from each other by the second plurality of strips. A portable livestock enclosure system is provided. While housing livestock in the portable livestock enclosure system, at least some of the livestock are grazed on the foraging crops by moving the portable livestock enclosure system through one or more of the second plurality of strips. The second plurality of strips is also fertilized by depositing manure from the livestock to the ground located beneath the portable livestock enclosure system. In one or more arrangements, crops are rotated among the first and second pluralities of strips of the field in subsequent seasons.

One or more example embodiments provide a portable livestock enclosure system configured to be easily moved along a set of rows to permit livestock to graze on forage crops and/or fertilizing the field.

### BRIEF DESCRIPTION OF THE DRAWINGS

Example embodiments are described in detail below with reference to the attached drawing figures, wherein:

FIG. 1 shows a perspective view of a field of forage crops.

FIG. 2 shows a perspective view of a field having alternating strips of forage crops and strips of planted row crops, consistent with one or more embodiments.

FIG. 3 shows a perspective view of the field having alternating strips of forage crops and strips of planted row crops, consistent with one or more embodiments; the view showing row crop matured.

FIG. 4 shows a perspective view of the field having alternating strips of forage crops and strips of planted row crops and a portable livestock enclosure system positioned in one of the strips of forage crops, consistent with one or more embodiments; the view showing row crop matured.

FIG. 5 shows a perspective view of a mobile barn of a portable livestock enclosure system, consistent with one or more embodiments.

FIG. 6 shows a side view of a mobile barn of a portable livestock enclosure system, consistent with one or more embodiments.

FIG. 7 shows a front view of a mobile barn of a portable livestock enclosure system, consistent with one or more embodiments.

FIG. 8 shows a close up side view of a rear wheel and rear suspension of a lift wheel assembly of a portable livestock enclosure system, consistent with one or more embodiments.

FIG. 9 shows a close up side view of a front wheel and front suspension of a lift wheel assembly of a portable livestock enclosure system, consistent with one or more embodiments.

FIG. 10 shows a top side floor plan diagram of a portable livestock enclosure system, consistent with one or more embodiments.

FIG. 11 shows a top side floor plan diagram of a portable livestock enclosure system, consistent with one or more embodiments; the view showing a portable pen positioned behind a rearward pen of the portable livestock enclosure system.

FIG. 12 shows a front view of a self-propelled portable livestock enclosure system, consistent with one or more embodiments; the view showing solar panels positioned on top of a roof of the portable livestock enclosure system.

FIG. 13 shows a top side floor plan diagram of a self-propelled portable livestock enclosure system, consistent with one or more embodiments.

FIG. 14 shows a block diagram of a control system for use with a portable livestock enclosure system, consistent with one or more embodiments.

FIG. 15 shows am upper front left perspective view of a portable livestock enclosure system, consistent with one or more embodiments.

FIG. 16 shows a right side view of a portable livestock enclosure system, consistent with one or more embodiments.

FIG. 17 shows a left side view of a portable livestock enclosure system, consistent with one or more embodiments.

FIG. 18 shows a top view of a portable livestock enclosure system, consistent with one or more embodiments.

FIG. 19 shows a front view of a portable livestock enclosure system, consistent with one or more embodiments.

FIG. 20 shows a rear view of a portable livestock enclosure system, consistent with one or more embodiments.

FIG. 21 shows an example schedule for a two season crop rotation with one forage crop and one row crop, consistent with one or more embodiments.

FIG. 22 shows an example schedule for a three season crop rotation with one forage crop and two different row crops, consistent with one or more embodiments.

FIG. 23 shows an example schedule for a four season crop rotation with one forage crop and two different row crops, consistent with one or more embodiments.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of farming, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of agricultural systems involving crop rotation. However, the embodiments are not so limited. It is appreciated that the embodiments may be adapted for use in other agricultural implements and in other applications, which may be improved by the disclosed structures, arrangements and/or methods. The system is merely shown and described as being used in the context of agricultural systems involving crop rotation for ease of description and as one of countless examples.

Although various embodiments may be primarily described with reference to stock cropping in a field having alternating strips of forage crops and strips of row crops, the embodiments are not so limited. Rather, it is understood that embodiments may be used to facilitate stock cropping in a field of any shape and/or having any other type of crops including but not limited to, for example, field crops (e.g., row crops, grain crops, oil crops, starch crops, sugar crops, cereal crops, fiber crops, pulse crops, and/or legumes) and/or specialty crops (e.g., fruits and vegetables, tree nuts, dried fruits, horticulture, nursery crops, and/or floriculture).

In addition to the above, it is anticipated that “row crops” used in association with the system presented herein are likely to be traditional and prevalent row crops such as corn, soybeans, wheat, cotton, sorghum, barley, rice, oats, canola, beans, peanuts, peas, sunflowers, sugar beets, rye, sugarcane, potatoes, and the like, or any combination thereof. However, the system is not so limited. Instead, it is hereby contemplated that the system may be used with any agricultural product or mix of agricultural products used as “row crops” including any grain crops, oil crops, starch crops, sugar crops, cereal crops, fiber crops, pulse crops, and/or legumes and/or specialty crops e.g., fruits and vegetables, tree nuts, horticulture, nursery crops, flowers, specialty grasses, mixed crops, orchards, or the like or any combination thereof. As such, unless stated otherwise, the term “row crops” is to be defined herein as any agricultural product or crop of a first kind or a mix of a first kind.

Similarly, in addition to the above, it is anticipated that “forage crops” used in association with the system presented herein are likely to be traditional and prevalent grass crops or pasture crops such as grasses, alfalfa, rye, cover crop, forage, mixed forage, weeds, fallow crops, native grasses, prevent plant crops, or the like or any combination thereof. However, the system is not so limited. Instead, it is hereby contemplated that the system may be used with any agricultural product or mix of agricultural products used as “forage crops” including any grain crops, oil crops, starch crops, sugar crops, cereal crops, fiber crops, pulse crops, and/or legumes and/or specialty crops e.g., fruits and vegetables, tree nuts, horticulture, nursery crops, flowers, specialty grasses, mixed crops, orchards, or the like or any combination thereof. As such, unless stated otherwise, the term “forage crops” is to be defined herein as any agricultural product or crop of a second kind or a mix of a second kind.

Furthermore, in some embodiments, the crops used for row crops and cover crops may be the different or the same. That is, when the crops are the same,

### Portable Livestock Enclosure System 10:

In various embodiments, a portable livestock enclosure system 10 (or simply system 10) may be formed of any suitable size, shape, and design that is configured to facilitate the holding, caring for, and moving of livestock 18 along a strip 16 of a field 12 for grazing and/or natural fertilization of the field 12. In the arrangement shown, as one example, system 10 includes a mobile enclosure (e.g., mobile barn 24), and a pair of enclosed grazing areas (e.g., a forward pen 26, and a rearward pen 28), among other components.

### Mobile Barn 24:

Mobile barn 24 is formed of any suitable size, shape, and design and is configured to shelter and protect livestock 18 from adverse weather and/or predators. In the arrangement shown, as one example, mobile barn 24, includes a frame 20, lift wheel assemblies 22, walls 30, an elevated floor 32, and a roof 34 among other components.

### Frame 20:

Frame 20 is formed of any suitable size, shape, and design that is configured to interconnect and support components of mobile barn 24, forward pen 26, and rearward pen 28 and facilitate movement of system 10 in field 12. In the arrangement shown, as one example, frame 20 extends between a front end 36 and a rear end 38 and extends between opposing sides 40. In this example arrangement, the frame 20 includes a lower section 42 extending between front end 36 and rear end 38 and between opposing sides 40. In this example arrangement, the frame 20 also includes an upper section 44 extending between front end 36 and rear end 38 and between opposing sides 40. In this example arrangement, upper section 44 of frame 20 and lower section frame 20 are connected by a number of side support members 46 of frame 20.

### Lift Wheel Assemblies 22:

Lift wheel assemblies 22 are formed of any suitable size, shape, and design and are configured to move a set of wheels 48/50 between a retracted position and an extended position to facilitate movement and placement of system 10 along strip 14 in field 12. In the arrangement shown, as one example, lift wheel assemblies 22 each include a wheel 48/50 and a suspension 52/54 operably connected to wheel 48/50 and frame 20. In this example arrangement, suspension 52/54 is configured to move wheel 48/50 between an extended position and a retracted position. The lift wheel assemblies 22 operate to hold frame 20 off of the ground when the wheels 48/50 are in the extended position. Conversely, the lift wheel assemblies 22 operate to set frame 20 on the ground when wheels 48/50 are in the retracted position.

Suspension 52/54 is formed of any suitable size, shape, and design and is configured to move a wheel 48/50 between the extended position and the retracted position. In the arrangement shown, as one example, a front suspension 52 is connected to front end of frame 20 and includes an upper lever 56, a lower lever 58, a front member 60 connected to a front wheel 48 by a wheel fork 90, and a rear member 62 connected to frame 20, and an expanding member 64. In this example arrangement, upper lever 56 extends from a front end 66, where it is connected to front member 60 by a hinged connection 68, to a rear end 70, where it is connected to rear member 62 by a hinged connection 72. In this example arrangement, lower lever 58 extends from a front end 74, where it is connected to front member 60 by a hinged connection 76, to a rear end 78, where it is connected to rear member 62 by a hinged connection 80.

Expanding members 64/98 are formed of any suitable size shape and design and is configured to be expanded/contracted in length by a user. In some various implementation, expanding member 64/98 may include but is not limited to, for example, a screw type jack, a farm jack, a hydraulic piston and/or bag, an air piston and/or bag, and/or any other known mechanism for lifting heavy objects.

In some various arrangements, expanding members 64/98 may be manually operated by user to facilitate movement of wheels 48/50 between the extended position and the retracted position. Additionally or alternatively, in one or more arrangements, expanding members 64/98 may be controlled, for example, by control system 300 to facilitate to lifting and/or lowering of system 10.

In the arrangement shown, as one example, expanding member 64 of front suspension 52 is a screw type jack expanding member extending between a front end 74 and a rear end 86. Front end 82 of expanding member 64 is connected to lower lever 58 near front end 74 by a hinged connection 84. Rear end 86 of expanding member 64 is connected to upper lever 56 near rear end 70 of upper lever 56.

In this example arrangement, when expanding member 64 is contracted, upper lever 56 and lower lever 58 are permitted to move closer to one another, which permits rear end 78 of lower lever 58 and rear end 70 of upper lever 56 to angle downward. When expanding member 64 is contracted enough, rear member 62 of front suspension 52 and frame 20 connected thereto lower to ground level to move front wheel 48 to a retracted position.

To move front wheel 48 to an extended position, expanding member 64 is expanded to force upper lever 56 and lower lever 58 to move further away from one another. As upper lever 56 and lower lever 58 move further away from one another, rear member 62 of front suspension 52 and frame 20 are moved upward, lifting frame off of the ground. When front wheel 48 is in the fully extended position, frame 20 is positioned at a suitable height to facilitate movement of system 10 in field 12.

As another example, in the arrangement shown, system 10 includes rear suspensions 54 connected rear wheels 50 to sides 40 of frame 20 near rear end of frame 20. In this example arrangement, rear suspension 54 includes a frame member 94 connected to frame 20, a lever 96, and an expanding member 98. In this example arrangement, lever 96 extends from a inward end 102, where lever 96 is operably connected to frame member 94 by a hinged connection 104, to a outward end 106, where lever 96 is connected to a rear wheel 50 by a hinged connection 118. In this example arrangement, the hinged connections 104 and 118 permit outward end 106 of lever 96 and rear wheel 50 to move up and down relative to frame 20. In this example arrangement, expanding member 98 is a screw type jack extending from a lower end 110 to an upper end 114. In this example arrangement, lower end 110 of expanding member 98 is connected to outward end 106 of lever 96 by a hinged connection 112. In this example arrangement, upper end 114 of expanding member 98 is connected to frame member 94 by hinged connection 116, at a position above the hinged connection 112 of expanding member 98, to lever 96.

In this example arrangement, when expanding member 98 is contracted, outward end 106 of lever 96 and rear wheel 50 are moved upward closer to hinged connection 116 of expanding member to frame member 94. When expanding member 98 is contracted enough, rear wheel 50 is raised to a retracted position where frame 20 is positioned at ground level. To move rear wheel 50 to an extended position, expanding member 98 is expanded to move outward end 106 of lever 96 and rear wheel 50 downward relative to frame 20, thereby lifting frame 20 off of the ground. When rear wheel 50 is in the fully extended position, frame 20 is positioned at a suitable height to facilitate movement of system 10 in field 12.

### Walls, Windows, and Doorways:

Walls 30 of mobile barn 24 are formed of any suitable size, shape, and design and are configured to form an enclosure for housing of livestock 18. In the arrangement shown, as one example, walls 30 includes a front wall 124, a rear wall 126, side walls 128, and an interior wall 136. In this example arrangement, front wall 124, rear wall 126, side walls 128, and interior wall 136 are wood boards attached to side support members 46 of frame 20. However, embodiments are not so limited. Rather, it is contemplated that walls 124, 126, 128, and 136 may be formed out of boards or panels of any material including but not limited to wood, plastic, metals, and/or composite materials.

In this example arrangement, front wall 124, rear wall 126, side walls 128, and interior wall 136 extend upward from lower section 42 of frame 20 to an upper end 134. In this example arrangement, mobile barn 24 includes open air windows 146 above upper ends 134 of front wall 124, rear wall 126, side walls 128. In the arrangement shown, as one example, windows 146 extend vertically between upper ends 134 and upper section 44 of frame 20 and extend horizontally between side support members 46.

In this example arrangement, side walls 128 extend between front end 36 of frame 20 and rear end 38 of frame 20. In this example arrangement, front wall 124 extends from a rightward one of the sides 40 of frame 20 to a forward doorway 140. In this example arrangement, rear wall 126 extends from a leftward one of the sides 40 of frame 20 to a rearward doorway 144. In this example arrangement, interior wall 136 extends from front end 36 of frame 20 to rear end 38 of frame 20 and divides the space within mobile barn 24 into a forward stall 138 and a rearward stall 142.

### Elevated Floor 32:

Elevated floor 32 is formed of any suitable size, shape, and design and is configured to support the weight of livestock 18 and facilitate removal of manure. In the arrangement shown, as one example, elevated floor 32 is positioned over lower section 42 of frame 20 extends from front end 36 to rear end 38 and between opposing sides 40 of frame 20. In this example arrangement, elevated floor 32 includes openings 148, which facilitate removal of manure through the elevated floor 32 and onto field 12 by hoof action. In various arrangements, elevated floor 32 may be formed using various different materials including but not limited to, for example, TENDERFOOT flooring, expanded metal grating, welded or forged metal grating, woven wire grating, and/or any other livestock flooring or suitable material with openings 148 to facilitate removal of manure through elevated floor 32 for deposition onto field 12.

### Roof 34:

Roof 34 is attached to upper section 44 of frame 20. Roof 34 is formed of any suitable size, shape, and design and is configured to cover mobile barn 24. In the arrangement shown, as one example, roof 34 includes roof supports 150 attached to upper section 44 of frame 20 and a roof covering 152 attached over roof supports 150.

### Roof Supports 150:

Roof supports 150 are formed of any suitable size, shape, and design and are configured to support roof covering 152 and facilitate attachment of roof covering 152 to upper section 44 of frame 20. In the arrangement shown, as one example, roof supports 150 are wooden joists extending across upper section 44 of frame 20 from front end 36. However, it is contemplated that roof supports 150 may any type of support structure including, joists, beams, I-beams, and/or any other support structure and may formed of any type of materials including but not limited to wood, plastic, metals, and/or composite materials. In this example arrangement, roof supports 150 are varied in height, with taller roof supports 150 positioned at the sides and shorter roof supports 150 positioned toward a center. As a result, roof covering 152 slopes toward the center where rainwater is fed to a gutter 170.

### Roof Covering 152:

Roof covering 152 is formed of any suitable size, shape, and design and is configured to shade and/or cover an interior of mobile barn 24. In the arrangement shown, as one example, roof covering 152 includes roof panels attached over roof supports 150. In various arrangements, roof covering 152 may include any type of roofing materials including but not limited to, for example., asphalt roofing, metal standing seam roofing, plastic standing seam roofing, concrete tile, metal aluminum shake, wood shake, concrete clay tile, vinyl roofing, rubber roofing, tar roofing, and/or any other roofing materials.

### Roof Siding 154:

In one or more arrangements, roof 34 includes roof siding 154 on a front 156, a back 158, and sides 160. Roof siding 154 is formed of any suitable size, shape, and design and is configured to cover a front 156, a back 158, and/or sides 160 of roof 34. In various arrangements, roof siding 154 may include any type of siding materials including but not limited to, for example, boards, panels, shingles, and/or any type of siding and formed of any materials including but not limited to wood, metal, vinyl, concrete, polymers, composites, and/or any other siding material.

### Rainwater Reclamation System 168:

In one or more arrangements, system 10 includes a rainwater reclamation system 168. Rainwater reclamation system 168 is formed of any suitable size, shape, and design and is configured to collect and store rainwater from gutter 162 for use by livestock 18 housed in mobile barn 24. In the arrangement shown, as one example, a rainwater reclamation system 168 includes gutter 170, a water line 172, a water barrel 174, an overflow line 178, and a livestock water dispenser 176 among other components. In operation, water gathered by gutter 170 is transported by water line 172 to water barrel 174 for storage. If water barrel 174 is full, excess water is transported by overflow line 178 to the strip 16 of row crops on one or both sides of system 10. In this example arrangement, livestock water dispenser 176 is connected to water barrel 174 and is configured to provide water from water barrel 174 to livestock 18 in mobile barn 24 for drinking. As an illustrative example, livestock water dispenser 176 may be configured to automatically fill a bowl with water from water barrel 174 to maintain drinking water in the bowl at a threshold level.

### Feeder System 180:

In one or more arrangements, system 10 includes a feeder system 180 (not shown) in mobile barn 24. Livestock feeder system 180 is formed of any suitable size, shape, and design and is configured to store and dispense feed for feeding of livestock 18 in one or more stalls 138/142 of mobile barn 24. In various arrangements, livestock feeder system 180 may include one or more of various types of feeders including but not limited to, for example, timed and/or untimed feeders, tub feeders, trough feeders, bunk feeders, hay feeders, grain feeders, creep feeders, mineral feeders, and/or any other livestock feeder.

As an illustrative example, in one or more arrangements, system 10 may be configured to house ruminant livestock 18 in forward stall 138 and forward pen 26, and house monogastric livestock 18 in rearward stall 142 and rearward pen 28. In this illustrative example, the ruminant livestock 18 may feed primarily on the strip 14 of forage crops in field 12 as system 10 is moved along, while the monogastric livestock 18 may be fed by livestock feeder system 180.

### Forward Pen 26:

Forward pen 26 is formed of any suitable size, shape, and design and is configured to provide an outdoor enclosure for livestock 18 housed in forward stall 138 of mobile barn 24. In the arrangement shown, as one example, forward pen 26 is formed of two side fences 184 and a front fence 198. In this example arrangement, side fences 184 have a generally rectangular shape extending from a lower end 186 to an upper end 188 and extending from a forward end 190 to a rearward end 192. In this example arrangement, front fence 198 has a generally rectangular shape extending from a lower end 200 to an upper end 202 and extending between opposing ends 204, where front fence 198 is connected to forward ends 190 of side fences 184. In this example arrangement, side fences 184, front fence 198, and front wall 124 of mobile barn 24 form an outdoor enclosure that livestock 18 housed in forward stall 138 of mobile barn 24 can enter and exit through forward doorway 140.

In this example arrangement, rearward ends 192 of side fences 184 are connected to front end 36 of frame 20 so that front fence 198 and side fences 184 of forward pen 26 are lifted off of the ground along with frame 20 when front wheels 48 and rear wheels 50 of lift wheel assemblies 22 are moved to the extended positions.

In this example arrangement, front fence 198 is connected to side fences 184 by hinged connections 206, which permit lower end 200 of front fence 198 to swing upward to a raised position and locked, for example, in a horizontal position to facilitate movement of system 10 in field 12. With lower end 200 of front fence 198 swung upward to the raised positions, a towing mechanism (e.g., hitch, tow cable, winch and/or other towing mechanism) can be operably attached to front end 36 of frame 20 (e.g., attached to lift wheel assembly 22 for front wheel 48) to facilitate towing of system 10 without obstruction by front fence 198. With front fence 198 in the raised position, system 10 can also be moved without damaging tall forage crops.

### Rearward Pen 28:

Rearward pen 28 is formed of any suitable size, shape, and design and is configured to provide an outdoor enclosure for livestock 18 housed in rearward stall 142 of mobile barn 24. In the arrangement shown, as one example, rearward pen 28 is formed of two side fences 214 and a rear fence 228. In this example arrangement, side fences 214 have a generally rectangular shape extending from a lower end 216 to an upper end 218 and extending from a forward end 220 to a rearward end 222. In this example arrangement, rear fence 228 has a generally rectangular shape extending from a lower end 230 to an upper end 232 and extending between opposing ends 234, where rear fence 228 is connected to rearward ends 222 of side fences 214. In this example arrangement, side fences 214, rear fence 228, and rear wall 126 of mobile barn 24 form an outdoor enclosure that livestock 18 housed in forward stall 138 of mobile barn 24 can enter and exit through rearward doorway 144.

In the arrangement shown, as one example, forward ends 220 of side fences 214 are connected to rear end 38 of frame 20 to facilitate lifting forward ends 220 of side fences 214 for moving of rearward pen 28 along with mobile barn 24 and forward pen 26. In this example arrangement, forward ends 220 of side fences 214 are connected to rear end 38 of frame 20 by hinged connections 236 configured to permit rearward ends 222 of side fences 214 and rear fence 228 to pivot down to ground level when frame 20 and forward ends 220 of side fences 214 are lifted off of the ground by lift wheel assemblies 22. In such position, rearward pen 28 can be dragged along with mobile barn 24 when moved while inhibiting certain livestock 18 (e.g., pigs) from escaping rearward pen 28 under fences 214/228. However, embodiments are not so limited. It is contemplated that, in some arrangements, rearward pen 28 may be attached to rear end 38 of frame 20 in a manner so rearward pen 28 is entirely lifted off of the ground along with frame 20 when front wheels 48 and rear wheels 50 of lift wheel assemblies 22 are moved to the extended positions.

### Dimensions and Transportation:

In various arrangements, components of system 10 may be formed of any heights, widths, and lengths to facilitate use in various different fields 12 and/or to facilitate transportation. In some various implementations, strips 14 of forage crops and strips 16 of row crops have the same width to facilitate crop rotation among the strips from season to season. In such implements, strips 14 of forage crops and strips 16 of row crops may be determined by the width of other farm machinery (e.g., tractor and/or combine). In various arrangements, system 10 may be adapted to be compatible for use with any width strips 14 of forage crops.

In the arrangement shown, as one example, mobile barn 24, forward pen 26, and rearward pen 28 of system 10 are each approximately 18 ft wide and 11 ft long. This example width provides room to accommodate rear wheels 50 in a 20 ft wide strips of field 12, which is one common width for planting 8 rows at 30 inch spacing (e.g., for planting of corn). However, embodiments are not so limited. Rather it is contemplated that in various arrangements, system 10 may be adapted to be any width to facilitate use in field with strips 16 of row crops having any spacing between rows and/or having any number of rows in each strip.

In this example arrangement, the 11 ft lengths of mobile barn 24, forward pen 26, and rearward pen 28 aid to facilitate easy transportation of system 10. For transportation of system 10, fences of forward pen 26 and rearward pen 28 may be dismantled and stacked to facilitate easier transportation (e.g., on public roads). In one or more arrangements, lift wheel assemblies 22 may be removed and repositioned on mobile barn 24 so as to permit mobile barn 24 to roll sideways. In such sideways configuration, mobile barn 24 has a width permitting mobile barn 24 to be towed behind a truck on a public road (e.g., as a wide load transport).

### Alternative Arrangement:

While the arrangements are primarily shown and discussed with reference to system 10 having a respective stalls 138/142 and pens 26/28 for housing two sets of livestock 18, the embodiments are not so limited. Rather, it is contemplated that in various arrangements system 10 may be adapted to include additional or fewer spaces for housing of livestock 18.

For example, in one or more arrangements, system 10 may be adapted to omit interior wall 136 to permit livestock 18 to move anywhere within the entirety of the mobile barn 24. Conversely, in one or more arrangements, system 10 may be adapted to include additional interior walls 136 to create a greater number of separate stalls within mobile barn. Additionally or alternatively, additional fences may be added to forward pen 26 and/or rearward pen 28 to subdivide the forward pen 26 and/or rearward pen 28 into a greater number of separate pens. Conversely, in one or more embodiments, fences may be removed provide a fewer number of pens by omitting forward pen 26 and/or rearward pen 28.

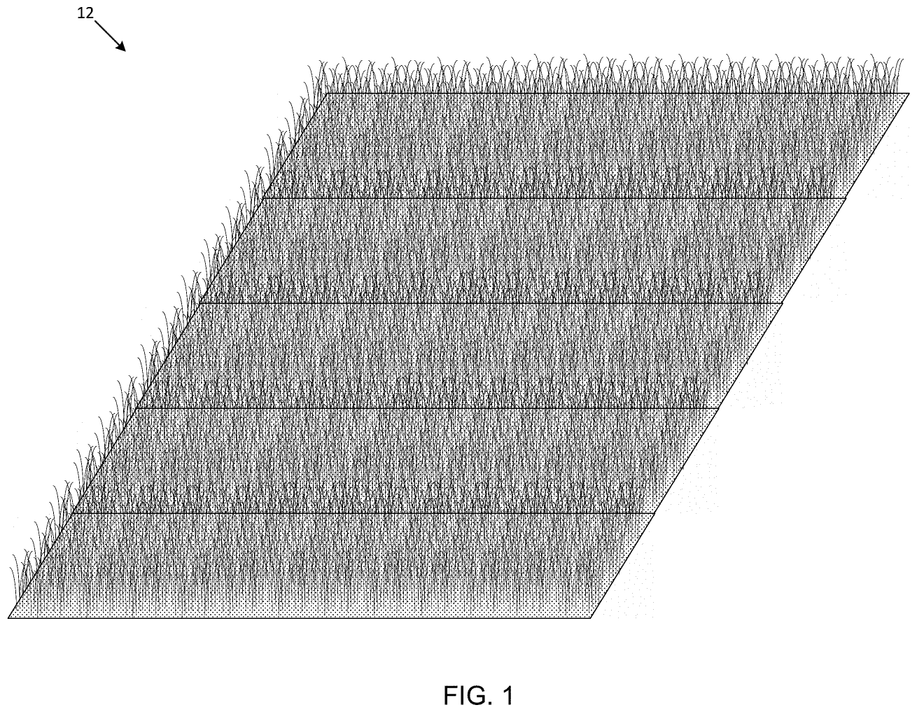

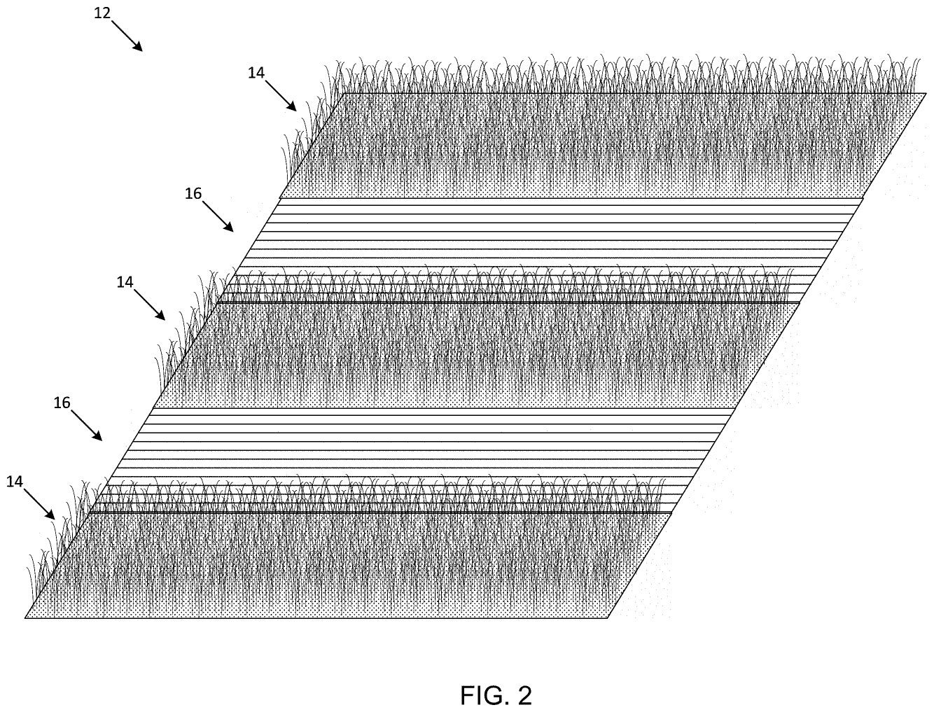

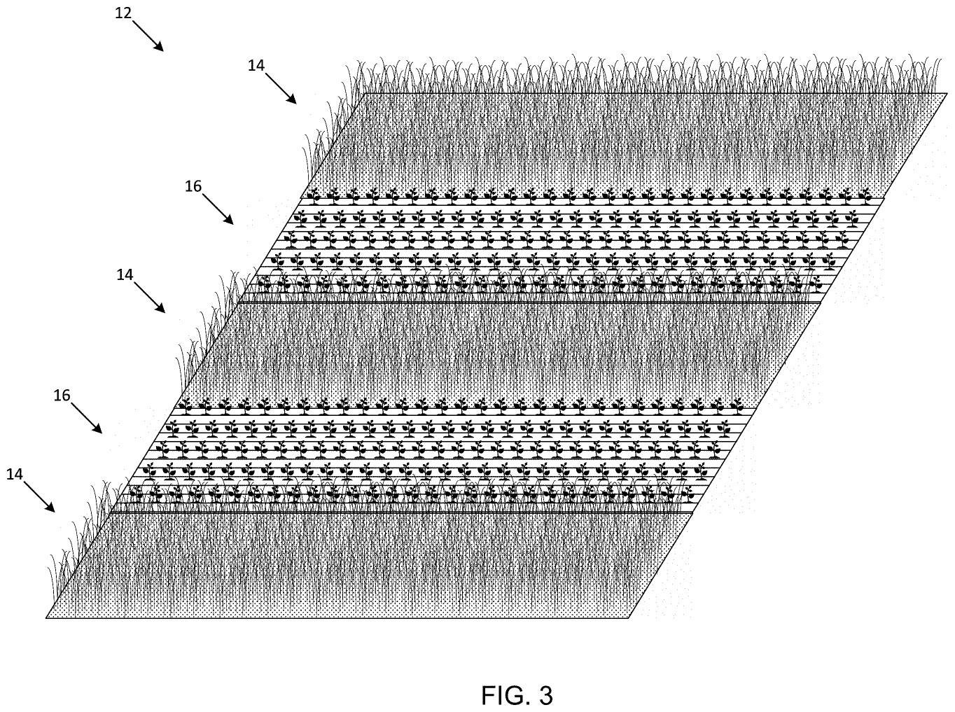

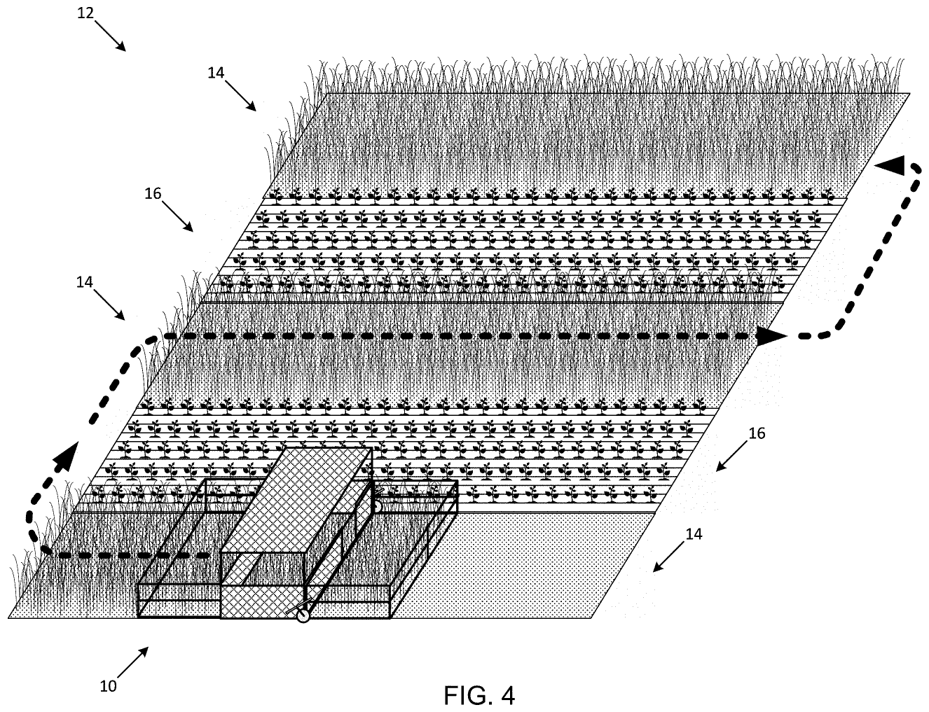

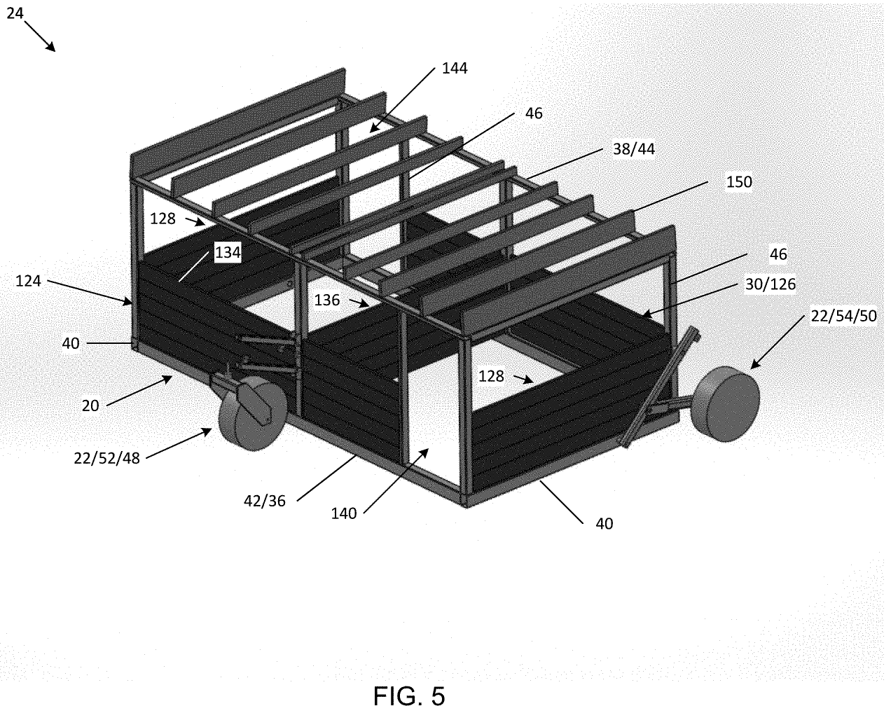

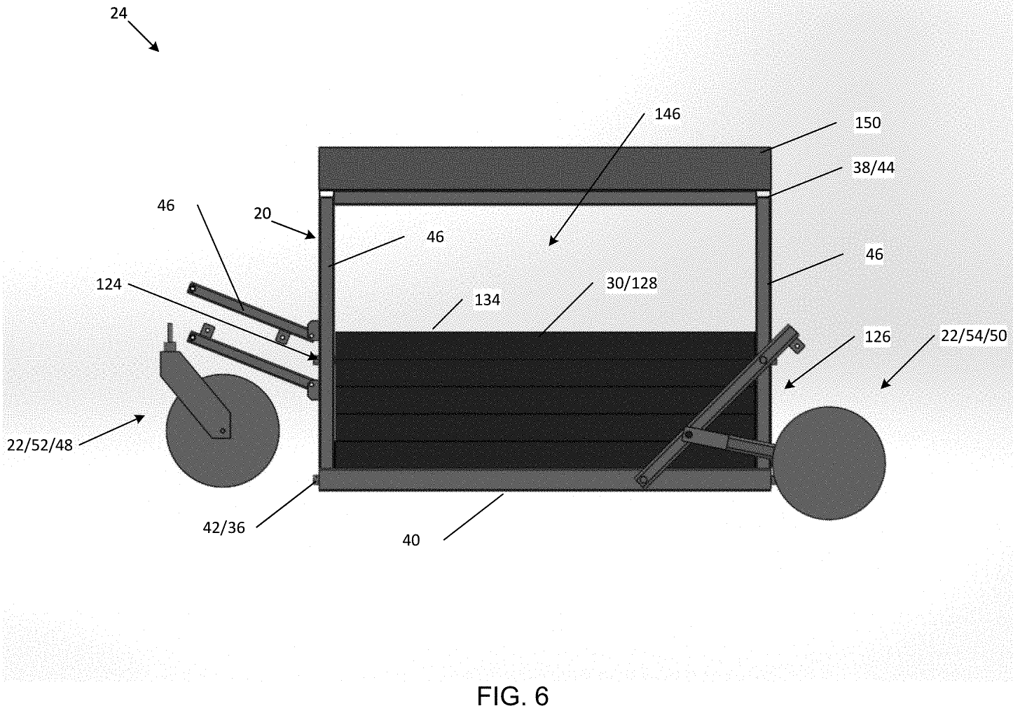

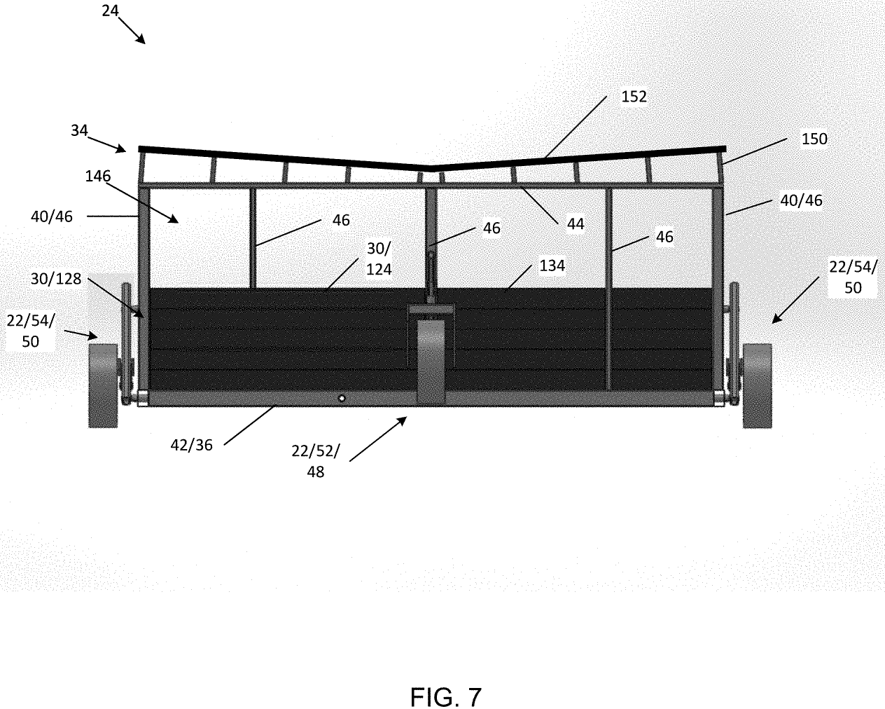

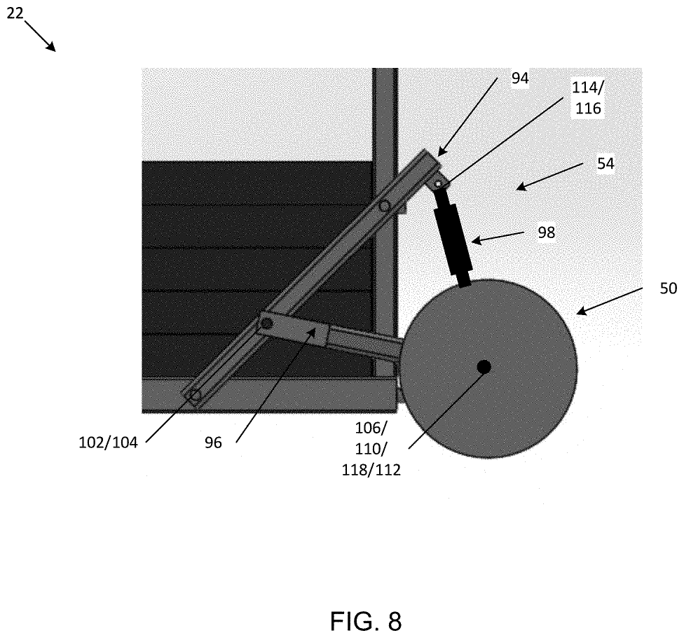

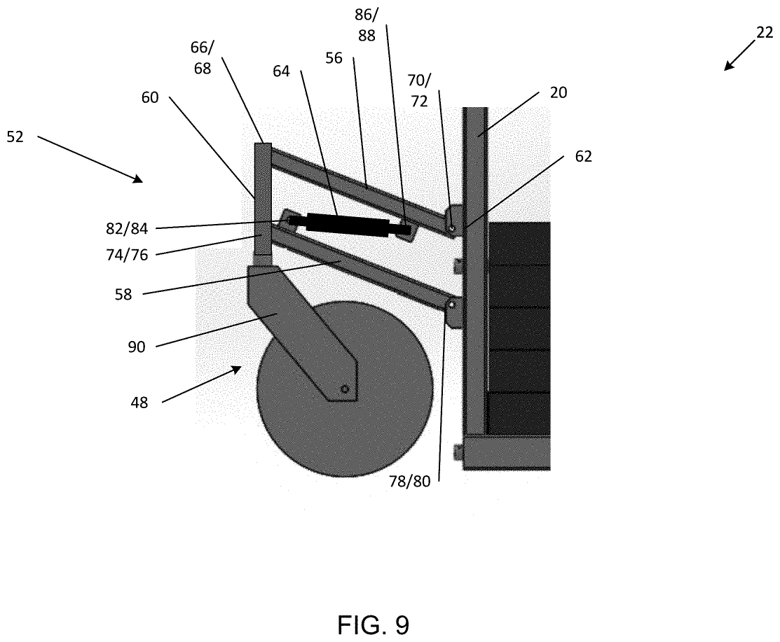

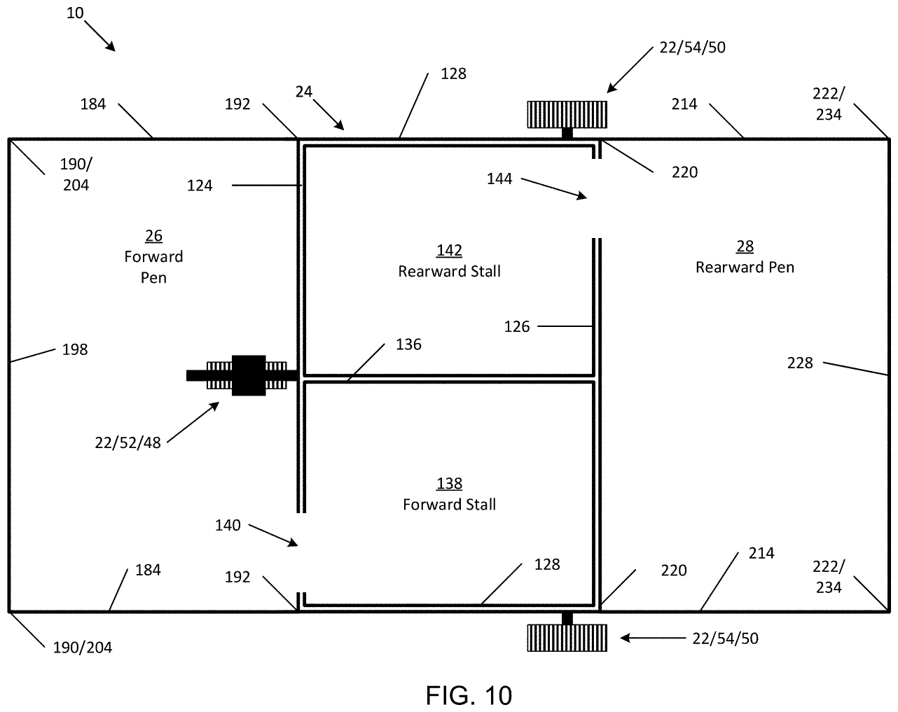

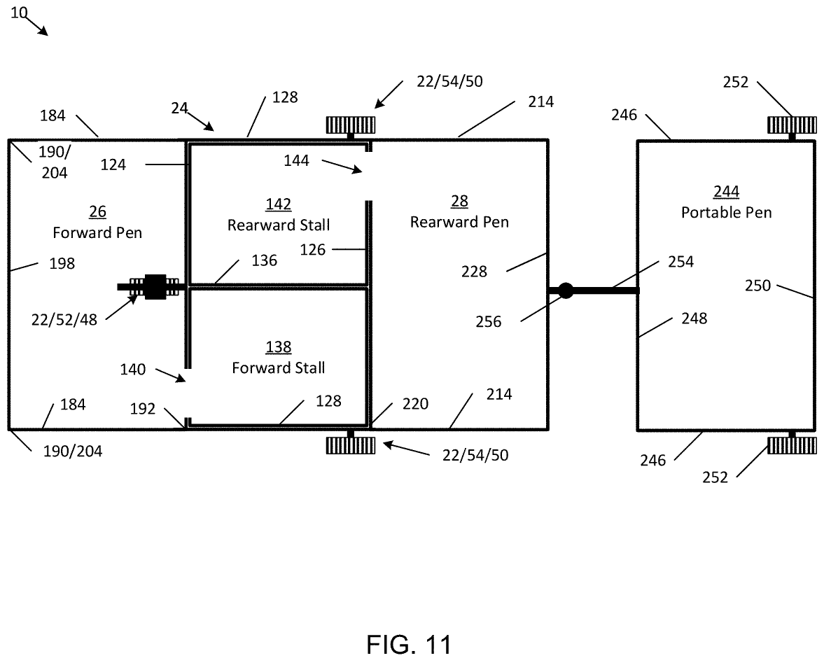

As another example, in one or more arrangements, system 10 includes one or more portable pens configured to connect to and move along with system 10. With reference to FIG. 11 an alternative arrangement of a portable livestock enclosure system 10 is presented. The arrangement shown in FIG. 11 is similar to the system 10 shown in FIGS. 1-10 and as such the disclosure related to the embodiment shown in FIGS. 1-10 applies to the embodiment shown in FIG. 11 unless stated specifically herein. In the alternative arrangement shown, system 10 additionally includes a portable pen 244 operably connected to rearward pen 28 of system 10.

### Portable Pen 244:

Portable pen 244 is formed of any suitable size, shape, and design and is configured to provide an additional enclosure for housing livestock 18 behind rearward stall 142 of mobile barn 24 and that can be moved along with system 10 along a strip 14 of forage crops.

In the arrangement shown, as one example, portable pen 244 is formed of two side fences 246, a front fence 248, and a rear fence 250. In this example arrangement, front fence 248 extends between and is coupled to front ends 262 of side fences 246. In this example arrangement, rear fence 250 extends between and is coupled to rear ends 264 of side fences 246.

In the example arrangement shown, portable pen 244 includes a trailer connection 254 configured to connect with a hitch 256 or other connection device connected to rear fence 228 of rearward pen 28. In this example arrangement, portable pen 244 includes a set of wheels 252 to facilitate movement of portable pen 244. With hitch 256 connected to rear fence 228 of rearward pen 28, wheels 252 hold fences 246, 248, and 250 a distance above the ground to facilitate movement of portable pen 244 while preventing livestock 18 from escaping portable pen 244 under fences 246, 248, and 250. Alternatively, in one or more arrangements, portable pen 244 may include a set of lift wheel assemblies 22 configured to move wheels 252 between extended and retracted positions, as discussed with reference to FIGS. 1-10 to facilitate lifting or lowering portable pen 244.

In operation: when system 10 is to be moved, portable pen 244 is suspended above ground by wheels 252 and/or lift wheel assemblies 22 and trailer connection 254 of portable pen 244 is connected to hitch 256 of rearward pen 28. As mobile barn 24, forward pen 26 and rearward pen 28 are moved forward, portable pen 224 is pulled forward by the trailer connection 254. Once system 10 is moved to the desired position, wheels 252 may be retracted to lower portable pen 244 to the ground if portable pen 244 includes lift wheel assemblies 22.

While this alternative arrangement is primarily shown and describe with reference to a pen 244 defined by fences 246, 248, and 250 without a top or floor, embodiments are not so limited. Rather, it is contemplated that, in one or more arrangements, portable pen 244 may be a coup, covered enclosure, having a top cover and/or bottom cover (such as mesh wire or the like) and/or any other form of livestock enclosure.

### Alternative Arrangement—Self Propelled Mobile Barn:

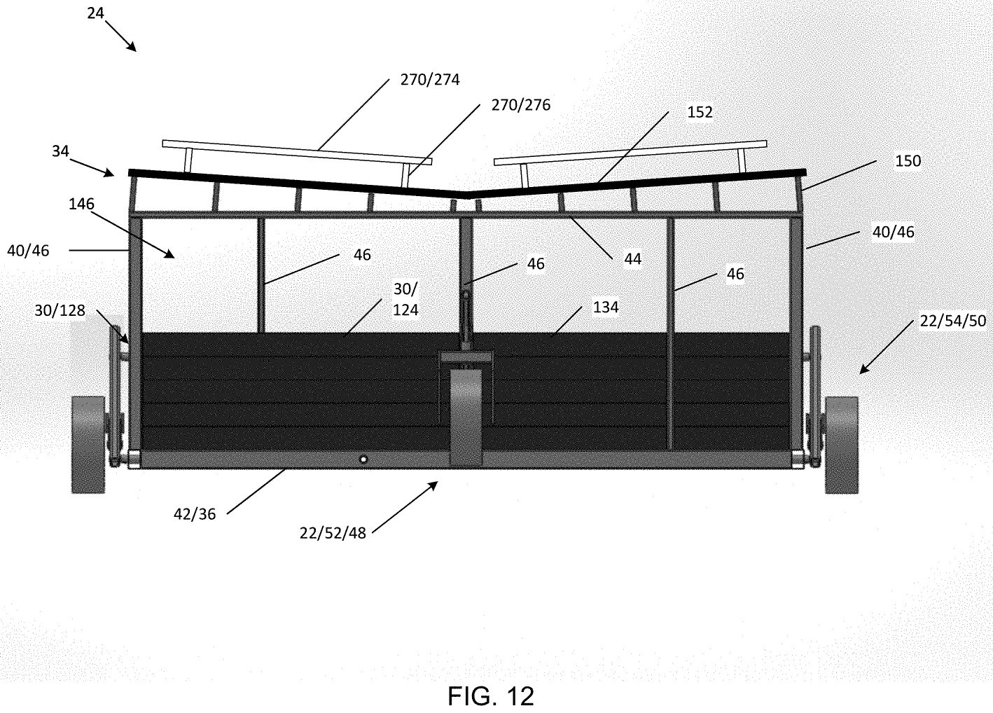

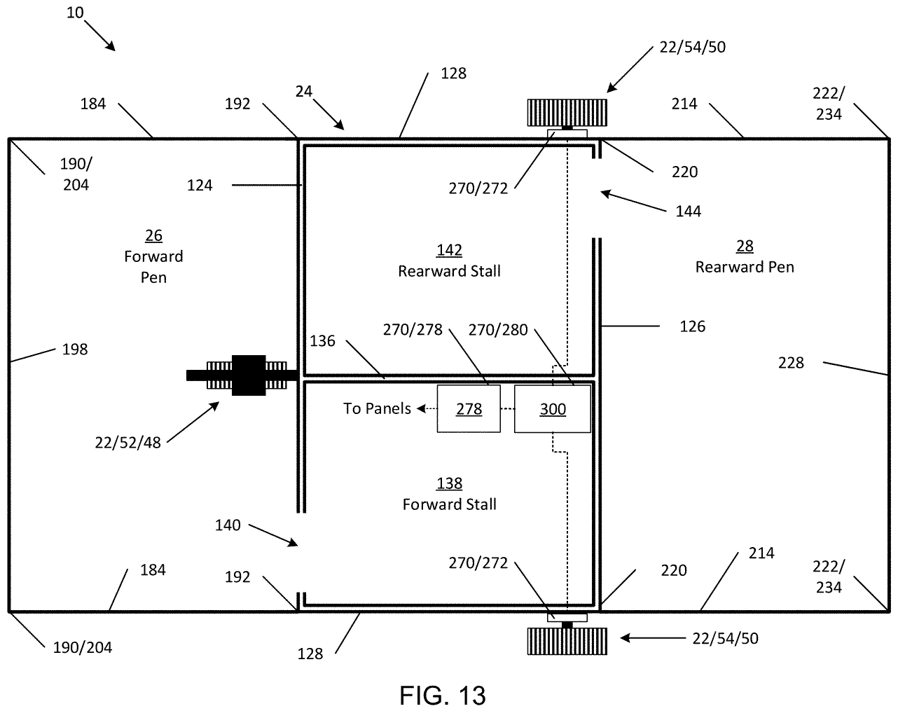

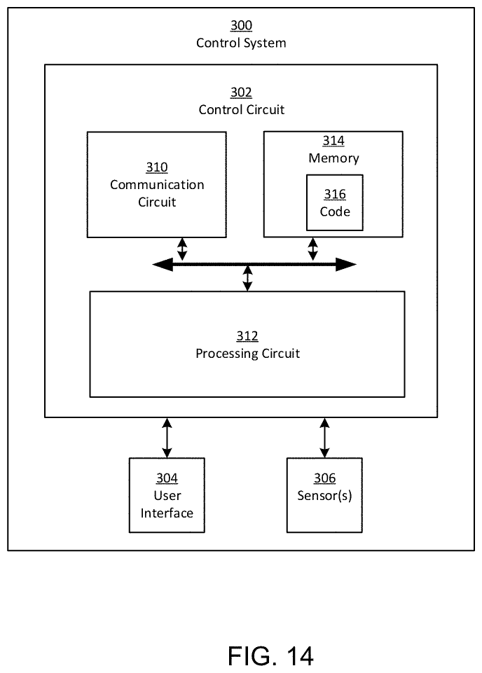

With reference to FIGS. 12-14 an alternative arrangement of a portable livestock enclosure system 10 is presented. The arrangement shown in FIGS. 12-14 is similar to the system 10 shown in FIGS. 1-11 and as such the disclosure related to the embodiment shown in FIGS. 1-11 applies to the embodiment shown in FIGS. 12-14 unless stated specifically herein.

While the arrangements are primarily shown and discussed with reference to system 10 being towed or pulled along a strip 14 of forage crops in field 12, the embodiments are not so limited. Rather, it is contemplated that, in various arrangements, system 10 may include a drive system 270 configured to move system 10 along the strip 14 of forage crops in field 12.

### Drive System 270:

Drive system 270 is formed of any suitable size, shape, and design and is configured to facilitate self-propelled movement of system 10. In the arrangement shown, as one example, drive system 270 includes one or more motors 272, solar panels 274, panel mounts 276, a power storage system 278, and a control system 300.

### Motors 272:

Motors 272 are formed of any suitable size, shape, and design and are configured to move system 10 when operated. In the example shown, as one example, drive system 270 includes two electric motors 272, each configured to drive a respective one of the rear wheels 50 when operated.

In this example arrangement, drive system 270 is configured to move system 10 forward or backward by operating motors 272 to apply an equal amount of power to each wheel 50. In this example arrangement, drive system 270 may steer or turn system 10 by operating motors 272 to apply a different amount of power to rear wheels 50. For example, applying more power to the left rear wheel 50 will cause system 10 to turn toward the right. Conversely, applying more power to the right rear wheel 50 will cause system 10 to turn toward the left. However, the embodiments are not so limited. Rather, it is contemplated that in one or more arrangements drive system 270 may be configured to move system 10 with any means or method for generating movement including but not limited to (1 wheel drive, front wheel drive, rear wheel drive, wheel drive, 4 wheel drive, all-wheel drive, track drive, or any other means of method for moving a vehicle). Similarly, it is contemplated that in one or more arrangements drive system 270 may turn system using various methods and means included but not limited to selected driving of wheels/tracks, steering arrangements, or any other known method or means for steering a vehicle.

### Solar Panels 274:

In this example arrangement, motors 272 are powered by solar panels 274. Solar panels 274 are formed of any suitable size, shape, and design and are configured to generate electric power from sunlight. In various embodiments, solar panels 274 may include various solar panel technologies including but not limited to, for example, Monocrystalline Solar Panels (Mono-SI), Polycrystalline Solar Panels (p-Si), Thin Film Solar Cell Panels (TFSC), Amorphous Silicon Solar Panels (A-SI), Biohybrid Solar Cell Panels, Cadmium Telluride Solar Cell Panels (CdTE), Concentrated PV Cell (CVP and HCVP), and/or any other type of solar panels.

### Panel Mounts 276:

In this example arrangement, solar panels 274 are mounted on top of roof 34 by panel mounts 276. Panel mounts 276 are formed of any suitable size, shape, and design and are configured to mount solar panels 274 on top of roof 34. In this example arrangement, panel mounts 276 are configured to mount solar panels 274 on roof 34 at the same angle as the slope of roof 34. However, embodiments are not so limited. Rather, it is contemplated that panel mounts 276 may mount solar panels 274 at a different angle to capture more sunlight or may include motorized tilt or turning mechanism to dynamically adjust orientation of solar panels 274 during the day to optimize power generation.

### Power Storage System 278:

In this example arrangement, power generated by solar panels 274 is used to charge power storage system 278. Power storage system 278 is formed of any suitable size, shape, and design and is configured to store electricity generated by solar panels 274 for later use.

In various arrangements, power storage system 278 may be implemented using various commercially available power storage systems, which may include various components including but not limited to, for example, one or more batteries, a voltage regulator, temperature sensors, voltage sensors, and/or current sensors. When power is generated by solar panels 274, the power is provided to power storage system 278 which uses the power to charge a battery (if not at maximum capacity). When system 10 is later to be moved in field 12, power stored in power storage system 278 is used to drive motors 272 to move system 10.

In one or more arrangements, power storage system 278, may be configure to transfer excess stored power to other agricultural systems of the farm, for use and/or sale to the power grid, when system 10 is docked with a barn or other structure.

size, shape, and design

### Control System 300:

In one or more arrangements, system 10 optionally includes a control system 300. Control system 300 is formed of any suitable any suitable size, shape, and design and is configured to control operation of lift wheel assemblies 22, motors 272, power storage system 278, and/or other components of system 10 to facilitate movement, steering, navigation, control lightly, dispensing or food/water, and/or other operation of system 10 in response to signals from sensors 306 and/or input from user interface 304. In the arrangement shown, as one example, control system 300 includes a control circuit 302, user interface 304, and/or sensors 306, among other components.

Although the control system 300 may be primarily described with reference to controlling components of system 10 having drive system 270 or self-propulsion of mobile barn 24, the embodiments are not so limited. Rather, it is contemplated that control system 300 may be optionally incorporated into any arrangement to facilitate control of lighting, feeding, monitoring, and/or any other operation performed by system 10.

### Control Circuit 302:

Control circuit 302 is formed of any suitable size, shape, design and is configured to control operation of various components of system 10 in response to signals of sensors 306 and/or input from user interface 304. In the arrangement shown, as one example implementation, control circuit 302 includes a communication circuit 310, a processing circuit 312, and a memory 314 having software code 316 or instructions that facilitates the operation of system 10.

Processing circuit 312 may be any computing device that receives and processes information and outputs commands according to software code 316 stored in memory 314. For example, in some various arrangements, processing circuit 312 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 314. Memory 314 may be any form of information storage such as flash memory, ram memory, dram memory, a hard drive, or any other form of memory.

Processing circuit 312 and memory 314 may be formed of a single combined unit. Alternatively, processing circuit 312 and memory 314 may be formed of separate but electrically connected components. Alternatively, processing circuit 312 and memory 314 may each be formed of multiple separate but communicatively connected components.

Software code 316 is any form of instructions or rules that direct processing circuit 312 bow to receive, interpret and respond to information to operate as described herein. Software code 316 or instructions is stored in memory 314 and accessible to processing circuit 312. As an illustrative example, in one or more arrangements, software code 316 or instructions may configure processing circuit 312 control circuit 302 to monitor sensors 306 and perform various preprogramed actions in response to signals from sensors 306 satisfying one or more trigger conditions.

As some illustrative examples, some actions that may be initiated by control circuit 302 in response to signals from sensors 306 and/or user input from user interface 304 include but are not limited to, for example, controlling lift wheel assemblies 22 to facilitate raising and/or lowering system 10, moving and/or navigating system 10, monitoring livestock 18, providing warnings before and/or while moving system 10, halting movement of system 10 in response to detecting livestock 18 in close proximity to fence, monitoring food and/or water levels, tracking livestock 18 inventory, and/or sending notifications to users (e.g., mails, SMS, push notifications, automated phone call, social media messaging, and/or any other type of messaging) regarding errors, low food and/or water, and/or any other status or notification regarding operation of system 10 and/or management of livestock 18.

Communication circuit 310 is formed of any suitable size, shape, design, technology, and in any arrangement and is configured to facilitate communication with devices to be controlled, monitored, and/or alerted by control system 300. In one or more arrangements, as one example, communication circuit 310 is a includes a transmitter (for one-way communication) or transceiver (for two-way communication). In various arrangements, communication circuit 310 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCl/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Sensors 306:

Sensors 306 are formed of any suitable size, shape, design, technology, and in any arrangement configured to measure factors pertaining to operation of system 10 and/or monitoring and/or management of livestock 18. In some various arrangements, sensors 306 may include but are not limited to, for example, location sensors (e.g., GPS sensors), position sensors, switches, motion sensors, speed sensors, proximity sensors, light sensors, cameras, microphones, LIDAR, speed sensors, temperature sensors, humidity sensors, moisture sensors, food and/or water dispenser sensors, fuel and/or energy sensors, and/or any other type of sensor, and/or various combinations thereof.

In some arrangements, sensors 306 may be formed along with control circuit 302 as a single combined unit. Alternatively, in some arrangement sensors 306 and control circuit 302 may be communicatively connected by communication circuit 310.

### User Interface 304:

User interface 304 is formed of any suitable size, shape, design, technology, and in any arrangement and is configured to facilitate user control and/or adjustment of various components of system 10. In one or more arrangements, as one example, user interface 304 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller balk or any other form of user input. Optionally, in one or more arrangements, user interface 304 includes a display (not shown). Display is formed of any suitable size, shape, design, technology, and in any arrangement and is configured to facilitate display information of settings, sensor readings, time elapsed, and/or other information pertaining to operation or system 10 and/or management of livestock 18 housed in system 10. In one or more arrangements, display may include, for example, LED lights, external area lighting (e.g., flood lights), meters, gauges, screen or monitor of a computing device, tablet, and/or smartphone. Additionally, or alternatively, in one or more arrangements, the inputs and/or display may be implemented on a separate device that is communicatively connected to control circuit 302. For example, in one or more arrangements, operation of control circuit 302 may customized using a smartphone or other computing device that is communicatively connected to the control circuit 302 (e.g., via Bluetooth, and/or the internet).

### Automated Control of System 10 by Control System 300:

### Movement, Steering, and Navigation:

In one or more example arrangements, control system 300 is configured to control operation of lift wheel assemblies 22 and/or motors 272 in response to user input (e.g., from user interface 304 of control system 300) to lift or lower mobile barn 24 and/or cause motors 272 to apply sufficient power to each of the rear wheels 50 to move and steer system 10 as desired. Additionally or alternatively, in one or more arrangements, control system 300 is configured to adjust dynamically adjust steering of system 10 in response to one or more sensors to aid in steering system 10 along the strip of forage crops without damaging adjacent row crops and/or to aid in turning from one strip 14 of forage crops to another. For example, control system 300 may adjust steering in response to various sensors 306.

In one or more arrangements, the control system 300 is configured to control navigation of system 10 entirely without any input from a user. For example, in some arrangements, control system 300 is configured to control lift wheel assemblies 22 and/or motors 272 to facilitate automated lifting of, movement and steering of, and lowering of system 10 according to a predetermined navigation path or prescription plan stored in memory 314 of control circuit 302. For example, in one or more arrangements, control system 300 is configured to perform a plurality of scheduled movements of system 10 along a predetermined path throughout the day. As an illustrative example, control system 300 may move system 10 three times a day, each time slowly moving system 10, for example, ten to fifteen ft over a matter of minutes. However, the embodiments are not so limited. Rather, it is contemplated that in one or more arrangements, control system 300 may be configured to move system 10 according to any schedule including any number of times per day/week/month/year. Similarly, it is contemplated that in one or more arrangements, control system 300 may be configured to move system 10 greater distances or shorter distances in each movement of system 10.

As an illustrative example, in one or more arrangements, control system 300 is configured to move system 10 by performing a series of operations including but not limited to, for example:
In response to a movement scheduled in a movement schedule stored in memory 314, accessing a predetermined navigation path or prescription plan stored in memory 314 to determine the desired movement(s) of system 10;
Causing lift wheel assemblies 22 to move wheels 48/50 to the extended position and thereby lifting mobile barn 24 and pens 24/26 off of the ground;
With mobile barn 24 and pens 24/26 lifted off of the ground, causing motor(s) to move and/steer systems along a path of the determined desired movement based on signals from one or more sensors (e.g., GPS sensors, positional sensors, cameras, light sensos, and/or LIDAR to name a few); and
Upon completing the desired movement, causing lift wheel assemblies 22 to move wheels 48/50 to the retracted position and thereby lowering mobile barn 24 and pens 24/26 back to the ground to complete the scheduled movement.

Additionally, in one or more arrangements, control system 300 may perform one or more operations to reduce the risk of injury to livestock 18 or nearby persons during movement of system 10. As one example, in one or more arrangements, control system 300 may be configured to trigger an alert (e.g., an audible and/or visual alert) prior to lifting, moving, and/or lowering system 10, to warn nearby persons of potential danger while system is moving. As another potential benefit, providing an alert prior to movement of system 10 may help train livestock 18 over time to move away from fences of pens 24/26 to avoid accidental injury during movement operations. As another example, in one or more arrangements, control system 300 may be configured to engage an electrified fencing system to proactively move livestock 18 away from fences of pens 24/26 or other dangerous areas prior to and/or while moving system 10. As yet another example, in one or more arrangements, control system 300 may monitor proximity of livestock 18 to fences of pens 24/26 or to other dangerous areas (e.g., using cameras, proximity sensors, motion sensors, switches, and/or LIDAR to name a few), and halt movement of system 10 in response to any livestock 18 being in close proximity to fences of pens 24/26 or to other dangerous areas.

Although the arrangements are primarily discussed with reference to control of a single system 10 by control system 300, the embodiments are not so limited. Rather, it is contemplated that in one or more arrangements, control system 300 may be configured to control and coordinate movement and/or operation of multiple (or even a swarm of) systems 10 and/or other agricultural systems including but not limited to, for example, tractors, combines, conveyors, monitor drones, and/or water systems to name a few).

Monitoring/Automated Actions and/or Alerts:

In one or more example arrangements, control system 300 is configured to facilitate monitoring of system 10 and/or livestock 18 and/or trigger various automated actions or alerts in response to detecting certain events. As one illustrative example, in one or more arrangements, control system 300 receive images or video from sensors continuously, periodically, and/or in response to prompt by a user to facilitate monitoring of livestock 18 and/or system 10. For instance, control system 300 may be configured to store, stream, or otherwise send pictures and/or video to a user device (e.g., a tablet, computer, a smartphone, and/or other device).

As another illustrative example, in one or more arrangements, control system 300 may be configured to provide alerts to a user to provide status updates and/or in response to detecting an error with system 10. For example, in some arrangements, control system 300 may be configured to provide an alert to a user in response to sensors 306 detecting levels of food, water, and/or power are low. In some various arrangements, alerts may be provided using various forms of communication including but not limited to, audible alerts, visual alerts (e.g., illuminating a status indicator light on system 10), emails, SMS, push notifications, automated phone call, social media messaging, and/or any other type of messaging.

As another it it strative example, in one or more arrangements, control system 300 may be configured to initiate various actions in response to sensors 306. As one illustrative example, control system 300 may be configured to cause system 10 to deploy a sunshade (not shown) or return system 10 to a barn in response to sensors 306 indicating high environmental temperatures that could cause harm to livestock 18. However, the embodiments are not so limited. Rather, it is contemplated that in some various arrangements, control system 300 may be configured to trigger any automated action in response to sensors 306 satisfying a trigger condition specified in memory 314.

In some arrangements, alerts, actions, and/or monitoring performed by control system 300 may be customized by a user. For example, in one or more arrangements, control system 300 may be customized by a user via user interface 304. As an illustrative example, in one or more arrangements, user interface 304 may provide an interface for a user to select one or more of the sensors 306 to be used to trigger the desired action(s). Next, user interface 304 may provide an interface for a user to select trigger conditions for performance of a desired action based on data from the selected sensors. Trigger conditions may include, for example, Boolean sensor states, various Boolean function based on of sensor values (e.g., threshold value triggers), and/or Boolean logic functions function of a combination of Boolean sensor states and/or Boolean functions. However, embodiments are not so limited. Rather, it is contemplated that in some various embodiments, trigger conditions may be specified in any configuration, arrangement, format, or structure. Next, user interface 304 may provide an interface for a user to select one or more devices to be controlled or alerted when the selected trigger conditions are satisfied. Next, user interface 304 may provide an interface for a user to select actions to be performed when the selected trigger conditions are satisfied. However, the embodiments are not so limited. Rather, it is contemplated that control system 300 may be customized by a user using various other methods and means known in the art.

### Logging and Source Verification:

In one or more arrangements, control system 300 is configured to facilitate logging of livestock 18 in an inventory system to facilitate management and tracking of purchases, breeding, feed and other costs, medical treatment, sales, and/or losses of livestock 18. For example, in one or more arrangements, each animal may be given a unique identifier that is associated with a record used for logging of data for the animal. In one or more arrangements, logged data for an animal may be logged in a cryptographic blockchain, thereby permitting production history or the animal to be verified.

In one or more arrangements, control system 300 is configured to generate QR codes (or other unique identifiers) that can be used by end-customers at whole sale markets, meat packers, retail markets, and/or restaurants, to verify the source of animal product and/or other information of interest relating to production history (e.g., feed types and/or housing conditions to name a few). For example, in one or more arrangements, the QR codes may be affixed to packaging on product for sale. A potential customer may scan the QR code (e.g., on a smartphone or other device), which provides a link to a webpage hosted by control system 300 that display information relating to the source and/or production history of the animal of the product for sale.

### Alternative Arrangement—Self Propelled Mobile Barn:

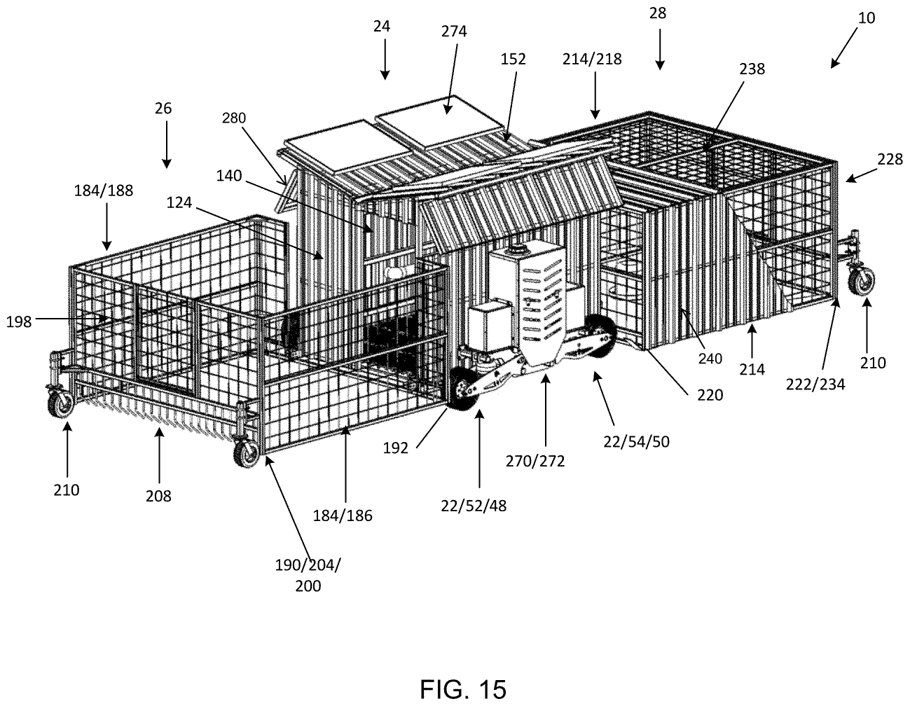

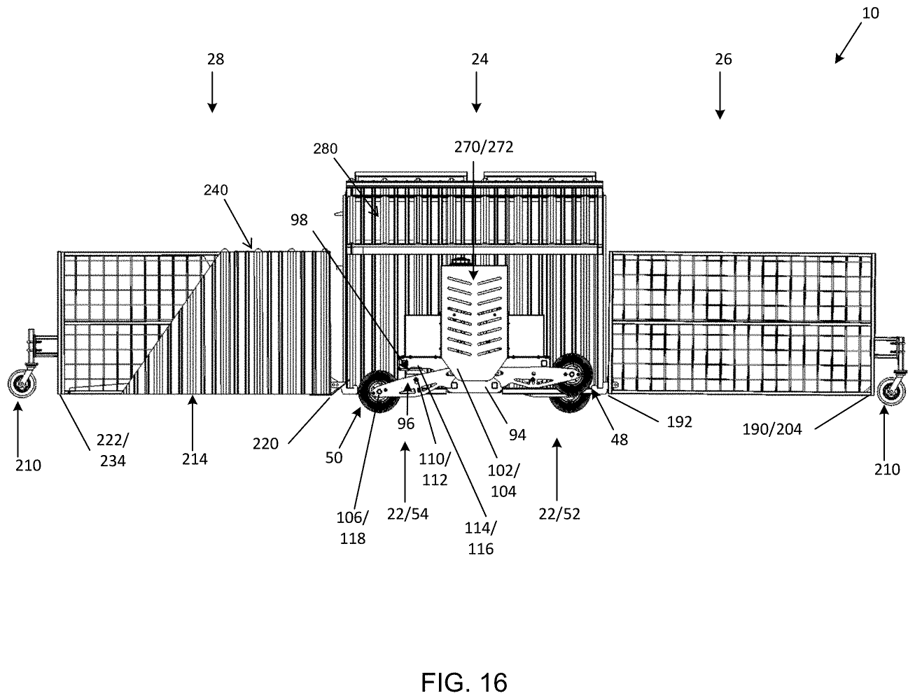

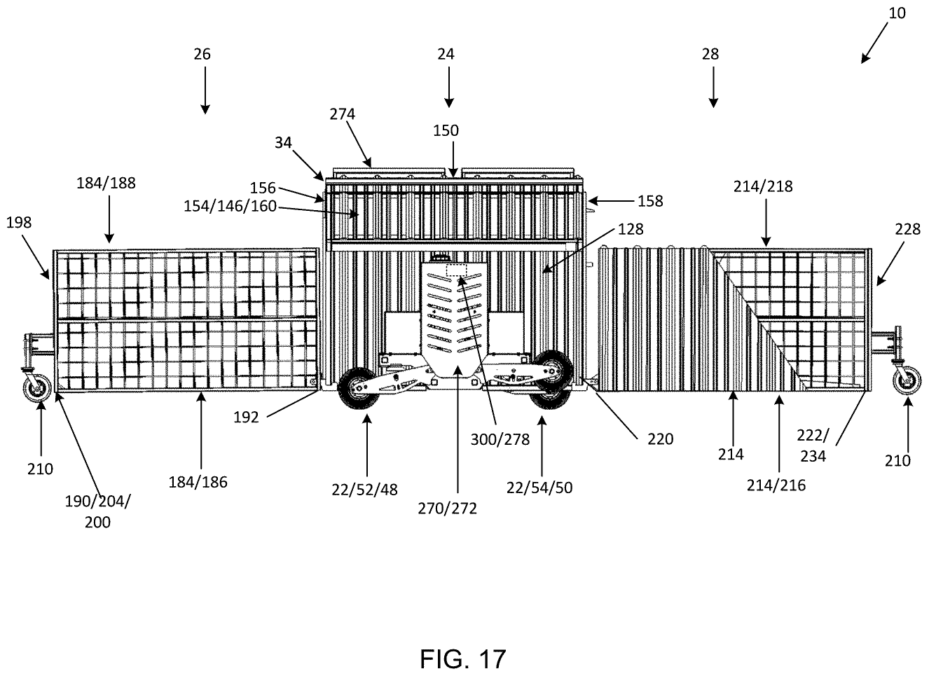

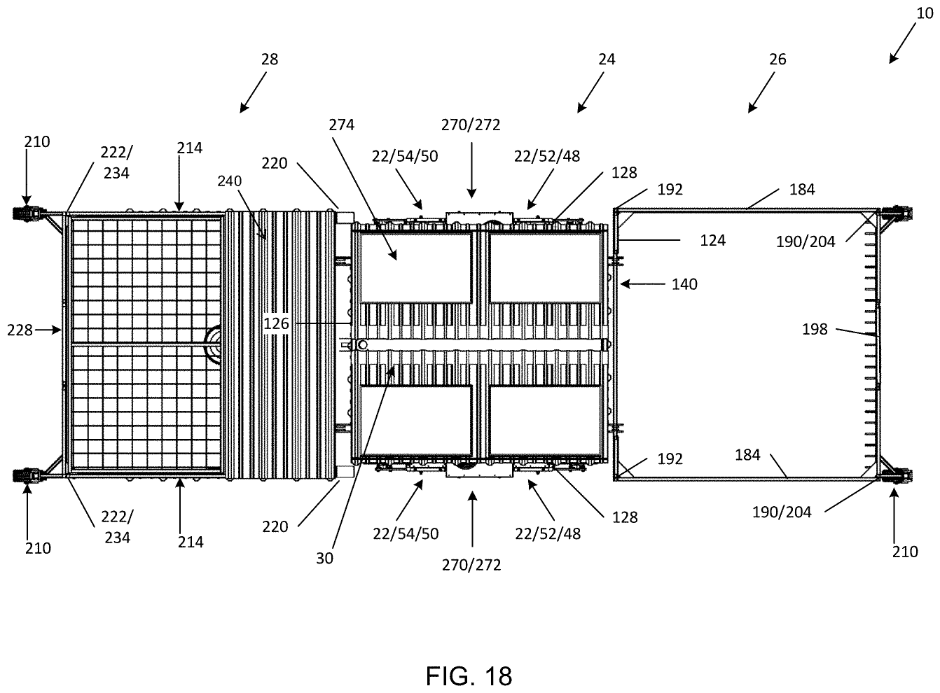

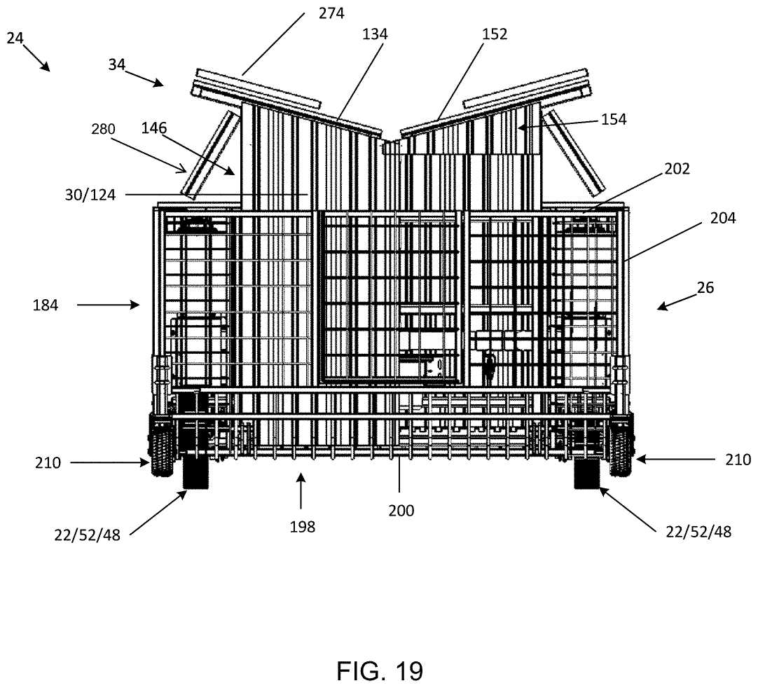

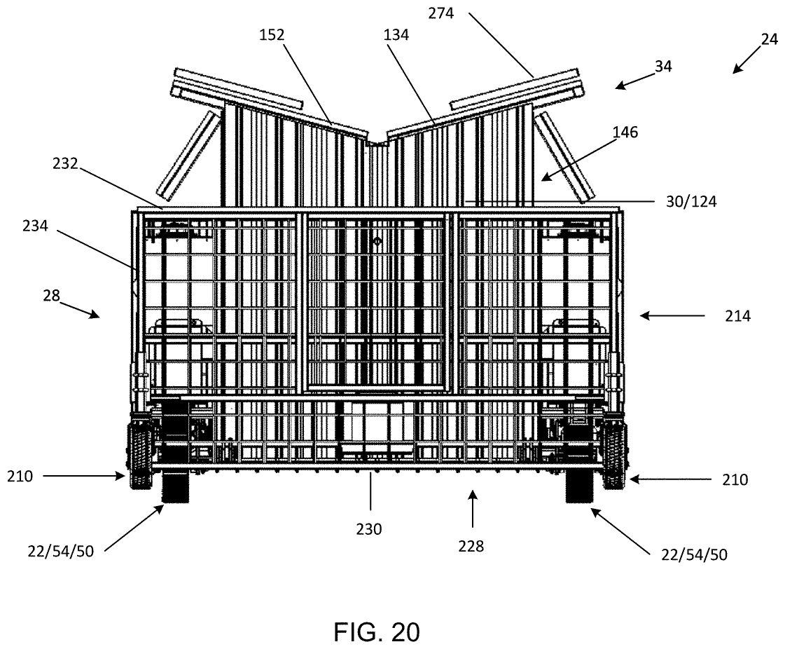

With reference to FIGS. 15-20 an alternative arrangement of a portable livestock enclosure system 10 is presented. The arrangement shown in FIGS. 15-20 is similar to the systems 10 shown in FIGS. 1-14 and as such the disclosure related to the embodiment shown in FIGS. 1-14 applies to the embodiment shown in FIGS. 15-20 19 unless stated specifically herein.

The primary differences in the system 10 shown in FIGS. 15-20 relates to the lift wheel assemblies 22 and motors 272. In the example arrangement shown in FIGS. 15-20, system 10 has a motor 272 and a pair of lift wheel assemblies 22 operably connected to each side of frame 20.

### Lift Wheel Assemblies 22:

Lift wheel assemblies 22 are formed of any suitable size, shape, and design and are configured to move wheels 48/50 between a retracted position and an extended position to facilitate movement and placement of system 10 along strip 14 in field 12. In the arrangement shown, as one example, lift wheel assemblies 22 each include a wheel 48/50 and a suspension 52/54 operably connected to wheel 48/50 and frame 20. In this example arrangement, suspension 52/54 is configured to move wheel 48/50 between an extended position and a retracted position. The lift wheel assemblies 22 operate to hold frame 20 off of the ground when the wheels 48/50 are in the extended position. Conversely, the lift wheel assemblies 22 operate to set frame 20 on the ground when wheels 48/50 are in the retracted position.

Suspension 52/54 is formed of any suitable size, shape, and design and is configured to move a wheel 48/50 between the extended position and the retracted position. In the arrangement shown, as one example, suspensions 52/54 each include a lever 96, frame member 94, and an expanding member 98. In this example arrangement, lever 96 extends from an inward end 102, where lever 96 is operably connected to frame member 94 by a hinged connection 104, to an outward end 106, where lever 96 is connected to a rear wheel 50 by a hinged connection 118. In this example arrangement, the hinged connections 104 and 118 permit outward end 106 of lever 96 and rear wheel 50 to move up and down relative to frame 20. In this example arrangement, expanding member 98 is a pneumatic piston and/or bag extending from a lower end 110 to an upper end 114. In this example arrangement, lower end 110 of expanding member 98 is connected to outward end 106 of lever 96 by a hinged connection 112. In this example arrangement, upper end 114 of expanding member 98 is connected to frame member 94 by hinged connection 116, at a position above the hinged connection 112 of expanding member 98, to lever 96.

Expanding members 64/98 are formed of any suitable size, shape, and design and are configured to be expanded/contracted in length by a user. In some various implementation, expanding member 64/98 may include but is not limited to, for example, a screw type jack, a farm jack, a hydraulic piston and/or bag, a pneumatic piston and/or bag, and/or any other known mechanism for lifting heavy objects. In some various arrangements, expanding members 64/98 may be manually operated by user to facilitate movement of wheels 48/50 between the extended position and the retracted position. Additionally or alternatively, in one or more arrangements, expanding members 64/98 may be controlled, for example, by control system 300 to facilitate to lifting and/or lowering of system 10.

In this example arrangement, when expanding members 64/98 are inflated, outward end 106 of levers 96 are moved downward relative to frame 20, thereby moving the wheels 48/50 to the extended position and lifting frame 20 off of the ground to facilitate movement of system 10. Conversely, when expanding members 64/98 are deflated, outward end 106 of levers 96 are permitted to move upward relative to frame 20, thereby permitting weight of system 10 to move the wheels 48/50 to the retracted position and rest frame 20 back onto the ground.

While the various arrangements are primarily shown with mobile barn 24 having two rear wheels 50 and one front wheel 48, or with two rear wheels 50 and two front wheels 48 the embodiments are not so limited. Rather, it is contemplated that system 10 may include more or fewer wheels 48/50 and/or positioned in different locations, in some various embodiments. Furthermore, while the arrangements are primarily shown with wheels 48/46 the embodiments are not so limited. For example, it is contemplated that some arrangements may additionally or alternatively include one or more tracks to facilitate movement of system 10.

### Support Wheel Assemblies 210:

In some various arrangements system 10 may include support wheel assemblies 210 to help hold system 10 of the ground and support system 10 during movement. In the arrangement shown, as one example, system 10 has support wheel assemblies 210 connected to lower end 200 or front fence 198 at opposing end 204 and to lower end 230 of rear fence 228 at opposing ends 234. In this example arrangement, support wheel assemblies 210 are configured to move between an upper position and a lower position while system 10 is raised off of the ground by lift wheel assemblies 22. In some arrangements, support wheel assemblies 210 may be configured to be moved manually by a user. Additionally or alternatively, in some arrangement, support wheel assemblies 210 may be configured to be moved between the upper position and lower position by an actuator or other automated mechanism (not shown), thereby permitting support wheel assemblies 210 to be automatically raised or lowered, for example, by control system 300.

### Forward Pen 26 and Rearward Pen 28:

It is understood that forward pen 26 and/or rearward pen 28 may be adapted to suit the needs of various different animals. In the arrangement shown, as one example, forward pen 26 has an open grazing area defined by front fence 198 and side fences 184 of forward pen 26 and front wall 124 of mobile barn 24. In this example arrangement, lower end 216 of front fence 198 of forward pen 26 a curved portion 208 that curves rearward to prevent the fence from getting hung on or damaging grazing crops, when moving system, while preventing larger ruminant livestock 18 from escaping front pen 26.

As another example, in the arrangement shown, rearward pen 28 has an enclosed area defined by rear fence 228, side fences 246 and a top cover fence 238 of rearward pen 28 and rear wall 126 of mobile barn 24. Top cover fence 238 helps prevent livestock 18 such as chickens from escaping over rear fence 228 or side fences 246. Additionally or alternatively, in one or more arrangements rearward pen 28 and/or forward pen 26 may have a bottom fence or grate (not shown) to prevent smaller livestock 18 escaping under the fences.

In this example arrangement, rearward pen 28 includes a sunshade 240 covering a portion of top cover fence 238 and side fences 246. Sunshade 240 is formed of any suitable size, shape, and design, and is configured to provide shade for livestock 18 in the rearward pen 28. In the arrangement shown, as one example, sunshade 240 is formed of the same material as that used for roof siding 154 and walls 124, 126, and 128 of mobile barn 24 (e.g., corrugated steel). However, the embodiments are not so limited. Rather, it is contemplated that in some various arrangements, system 10 may include a sunshade 240 or other protection against weather formed of various materials (e.g., wood, metal, plastic, fibers, and/or other materials) and which may be positioned anywhere in system 10.

### Windows 146:

In this example arrangement, windows 146 of mobile barn 24 are covered by shutter type window covers 280, that are connected by hinges (not shown) to mobile barn 24 along a top edge. However, the embodiments are not so limited. Rather, it is contemplated that in some various arrangements, system 10 may include other types of window coverings (e.g., plastic windows, glass windows, plastic sheeting, bifold, rolling, and/or other types of shutters) or window coverings may be omitted entirely. In some arrangement, windows 146 may manually opened by a user (for example by engaging latches, hand crank, and/or other manually operated mechanism for opening and/or closing windows. Additionally or alternatively, in some arrangements, windows 146 may be automatically opened and/or closed by an or other automated mechanism (not shown), thereby permitting windows 146 to be automatically opened and/or closed, for example, by control system 300.

### In Operation—Grazing Livestock Along a Strip of Forage Crops:

With reference to the arrangements shown in FIGS. 1-20, system 10 is configurable to facilitate simultaneous housing of multiple different types of livestock 18 to promote biodiversity of soil organisms and better control of nutrients provided by organic fertilization using system 10. In one or more arrangements shown, as one example, system 10 is configured to house ruminant livestock 18 (e.g., cattle, sheep and/or goats to name a few) in forward stall 138 and forward pen 26. In this example arrangement, system 10 is configured to house monogastric livestock 18 in rearward stall 142 and rearward pen 28. In this example arrangement, system 10 is also configured to house avian livestock 18 in a portable pen 244 following rearward pen 28. In this illustrative example, the ruminant livestock 18 may feed primarily on the strip 14 of forage crops in field 12 as system 10 is moved along, while the monogastric and avian livestock 18 may be fed by livestock feeder system 180.

In operation, system 10 is positioned at one end of a strip 14 of forage crops in field 12 so forage crops are available to ruminant livestock 18 in forward pen 26 and frame 20 is lowered by moving front wheel 48 and rear wheels 50 to retracted positions. The livestock 18 feed and fertilize field 12 at this location until forage crops of strip 14 in forward pen 26 have been grazed. At which time, system 10 is moved forward along strip 14 to position forward pen 26 where more forage crops are available.

As an illustrative example process for movement of system 10, any ruminant livestock 18 in forward pen 26 are first moved to and shut into forward stall 138 of mobile barn 24. Lower end 200 of front fence 198 is swung upward to an upper position and locked into place. Frame 20 of system 10 is raised by moving front wheel 48 and rear wheels 50 of lift wheel assemblies 22 to extended positions.

In this illustrative example, to move front wheel 48 to the extended position, expanding member 64 of front suspension 52 is rotated to expand expanding member 64 and force upper lever 56 and lower lever 58 of front suspension 52 to move further away from one another. As upper lever 56 and lower lever 58 move further away from one another, rear member 62 of front suspension 52 and frame 20 are moved upward, lifting front end 36 of frame 20 off of the ground.

In this illustrative example, to move rear wheels 50 to the extended position, expanding member 98 of each rear suspension 54 is rotated to expand expanding member 98. As expanding member 98 is expanded, outward end 106 of lever 96 of rear suspension 54 and the rear wheel 50 connected thereto are moved downward relative to frame 20, thereby lifting frame 20 off of the ground. When rear wheel 50 is in the fully extended position, frame 20 is positioned at a suitable height to facilitate movement of system 10 in field 12.

In this illustrative example, forward pen 26 is lifted along with frame 20. In this example, forward ends 220 of side fences 214 of rearward pen 28 is also lifted along with frame 20. In this example arrangement, due to hinged connections 236 between rearward pen 28 and frame 20, rearward end 222 of side fences 214 of rearward pen 28 and rear fence 228 remain at ground level as frame 20 is lifted. By keeping rearward end 222 of side fences 214 of rearward pen 28 and rear fence 228 at ground level, livestock 18 in rearward pen 28 are inhibited from escaping from under fences 214 and 228.

In this illustrative example, front wheel 48 and rear wheels 50 in extended positions, system 10 is moved forward along the strip 14 of forage crops by towing system 10 forward. In this example, a tow cable of a winch positioned at the other end of the strip 14 of forage crops is connected to front end 36 of from 20 (e.g., connected to front suspension 52). The winch is engaged to pull system 10 forward until forward pen 26 is positioned over fresh forage crops.

In the new position, system 10 is lowered by moving front wheel 48 and rear wheel 50 to retracted positions. In this illustrative example, to move front wheel 48 to the retracted position, expanding member 64 of front suspension 52 is rotated in the opposite direction to contract expanding member 64 and permits upper lever 56 and lower lever 58 of front suspension 52 to move closer to one another, which permits rear end 78 of lower lever 58 and rear end 70 of upper lever 56 to angle downward. When expanding member 64 is contracted enough, rear member 62 of front suspension 52 and front end 36 of frame 20 are moved to ground level.

In this illustrative example, to move rear wheels 50 to the retracted position, expanding member 98 of each rear suspension 54 is rotated in the opposite direction to contract expanding member 98. As expanding member 98 is contracted, outward end 106 of lever 96 of rear suspension 54 and the rear wheel 50 connected thereto are moved upward relative to frame 20. When rear wheel 50 is in fully retract position, rear end 38 of frame 20 is placed onto the ground.

Once both front end 36 and rear end 38 of frame 20 are placed onto the ground, lower end 200 of front fence 198 is swung downward to enclose forward pen 26. Once forward pen 26 is enclosed, ruminant livestock 18 may be permitted to return to forward pen 26 from forward stall 138 of mobile barn 24.

The livestock 18 feed and fertilize field 12 at this new location until forage crops of strip 14 in forward pen 26 have again been grazed. At which time, system 10 is again moved forward along strip 14 to position forward pen 26 where more forage crops are available. The above process is repeated until system 10 reaches to the end of the strip 14 of forage crops.

When the end of the strip 14 of forage crops is reached, system 10 is moved forward and turned around an adjacent strip 16 of row crops to position system 10 at one end of a new strip of forage crops. Due to the alternating strips 14 of forage crops and strips 16 of row crops, movement of system 10 from one strip 14 of forage crops to another can be accomplished with a wider turn, which is much easier to perform in comparison to turning into an adjacent row. Similarly, when planting or harvesting row crops, movement of a tractor or combine from one strip 16 of row crops to another can be achieved with a much wider and easier turn.

While the arrangements are primarily described with reference to system 10 making a single pass over each strip of forage crops in a season, embodiments are not so limited. Rather it is contemplated that as forage crops regrow, system 10 may be redeployed over a strip of forage crops any number of times depending on the type of livestock 18 housed in system 10 and manure management plan implemented for field 12.

### In Operation—Crop Rotations and Schedules:

In various arrangements, system 10 may be used in conjuncture with intercropping and/or crop rotation among strips of the same field 12 to balance nutrient use, increase productivity, manage weeds, and/or promote biodiversity.

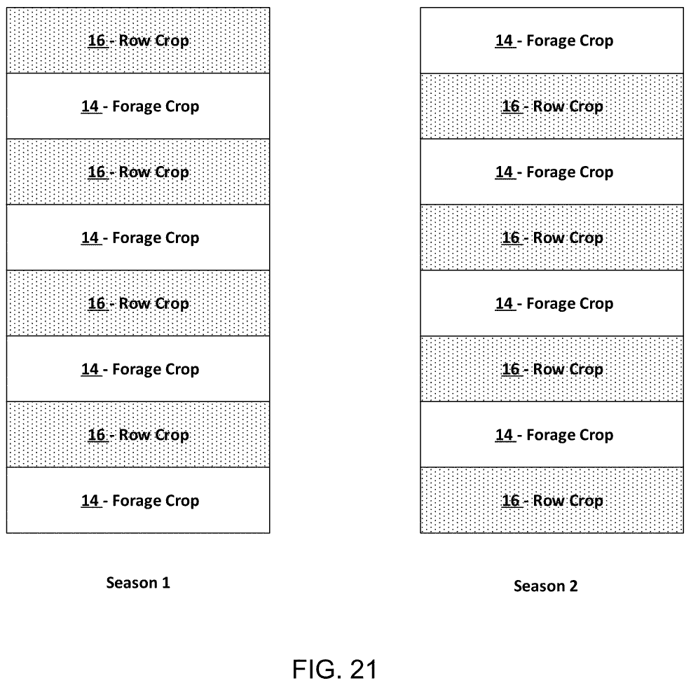

In various arrangements, crop rotation may include various number of crops and various numbers of seasons in each crop rotation cycle. FIGS. 21-23 show some example schedule for crop rotation to facilitate stock cropping using system 10.

FIG. 21 shows an example schedule for a two season crop rotation with one forage crop and one row crop. In this example, rotation for a given strip of field 12 may include: growing a row crop a first season and growing a forage crop a second season. The schedule then repeats starting in a third season with growing of the row crop in the strip.

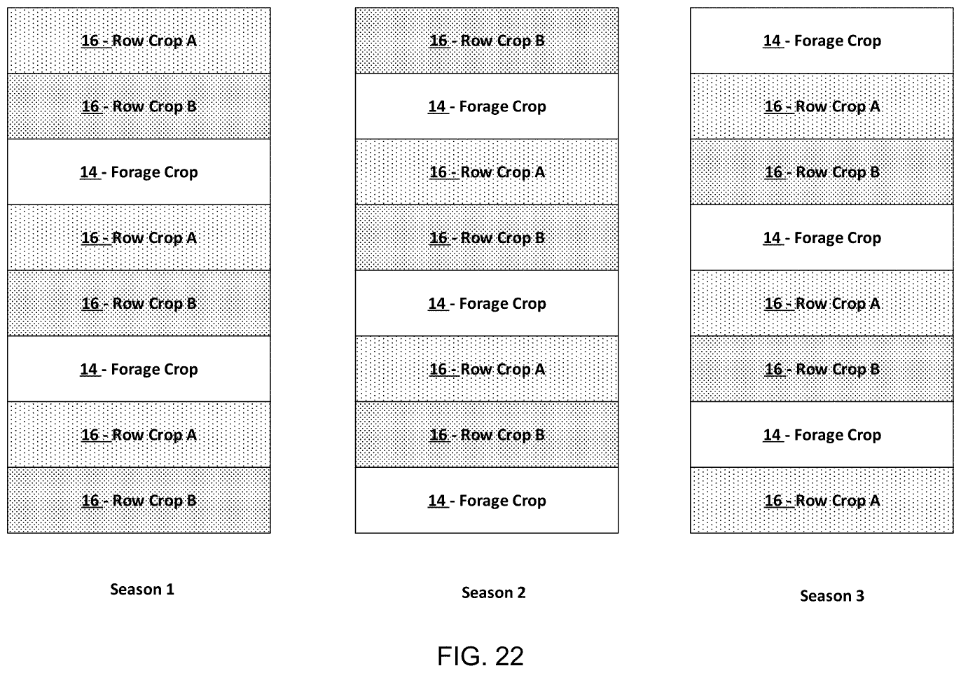

FIG. 22 shows an example schedule for a three season crop rotation with one forage crop and two different row crops. In this example, rotation for a given strip of field 12 may include: growing a first row crop a first season, growing a second row crop a second season, and growing a forage crop a third season. The schedule then repeats starting in a fourth season with growing of the first row crop in the strip.

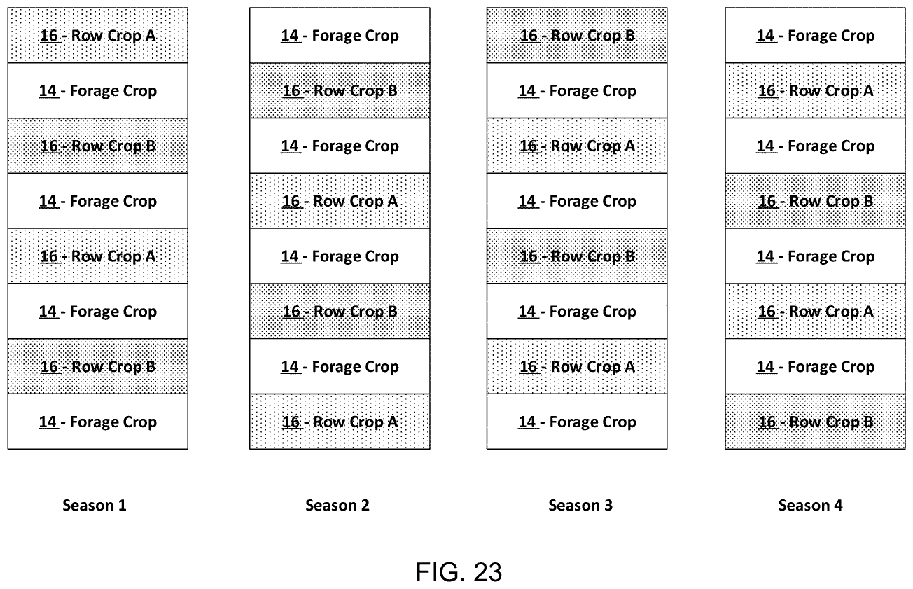

FIG. 23 shows an example schedule for a four season crop rotation with one forage crop and two different row crops. In this example, rotation for a given strip of field 12 may include: growing a first row crop a first season, growing a forage crop a second season, and growing a second row crop a third season, and growing a forage crop a fourth season. The schedule then repeats starting in a fifth season with growing of the first row crop in the strip.

As an illustrative example, to facilitate stock cropping, crop seed may be spread over row crops in the summer of previous season forage for use as cover crop. In fall of the previous season, row crops are harvested while leaving forage crops in field. In the following spring, strips of field 12 for growing row crops and forage crops are determined according to a crop rotation schedule. Strips 16 of the field 12 designated for row crops are plowed, tiled, sprayed, or otherwise prepared for planting of row crops. Row crops are planted in the strips 16 once prepared. The strips 16 having row crops planted are separated by strips 14 where forage crops remain.

During the growing season, row crops are grown on strips 16. At the same time, livestock 18 is grazed on the strips 14 of forage crops using system 10 and strips 14. As previously described, system 10 is slowly moved along the strips of forage crops from strip to strip, to facilitate grazing of livestock 18 housed in system 10 and/or fertilize field 12 with manure of the livestock 18.

At some point during the growing season forage crop seed is spread over strips 16 of row crops. In fall, the strips 16 of row crops are harvested leaving underlying forage crops. In the next spring, the process is repeated with strips for forage crops and strips for row crops determined by the next stage in the crop rotation schedule.

### Not Limited to Intercropping:

Although some various arrangements of system 10 may be primarily described with reference to intercropping or stock cropping in a field having alternating strips of forage crops and strips of row crops, the embodiments are not so limited. Rather, it is understood that system 10 may be embodiments may be used to facilitate stock cropping along any spare land that may be available including but not limited to, land rows in orchards, land between buildings, non-farmable land along lowlands, and/or any other available land. System 10 is thought to facilitate easier entrance into livestock husbandry, without the need to invest in expensive fencing to contain livestock and/or protect livestock from predators.

From the above discussion it will be appreciated that the portable livestock enclosure system presented herein improves upon the state of the art. More specifically, and without limitation, it will be appreciated that the system presented herein: facilitates grazing of livestock in a field; facilitates concurrent grazing of livestock and planting of row crops in a field; houses multiple different types of animals; organically fertilizes a field during use; improves planting yields; improves biodiversity; assists with manure management; is relatively inexpensive; is easy to deploy; is easy to move; is easy to transport between fields; can be transported on public roads; has a long useful life; is durable; has a robust design; is high quality; and/or is easy to use.

Example embodiments of the invention have been described in an illustrative manner. It is to be understood that the terminology that has been used is intended to be in the nature of words of description rather than of limitation. It will be appreciated by those skilled in the art that other various modifications could be made to the device without parting from the spirit and scope of this disclosure. All such modifications and changes fall within the scope of the claims and are intended to be covered thereby.

What is claimed:

1. A portable livestock enclosure system, comprising:
a mobile enclosure;
the mobile enclosure including a frame;
wherein the frame has front end, a rear end, and opposing sides;
a first enclosed grazing area connected to the frame of the mobile enclosure;
a set of lift wheel assemblies operably connected to the frame;
wherein the set of lift wheel assemblies are configured to move a set of wheels between a retracted position and an extended position;
wherein the mobile enclosure and first enclosed grazing area are lifted off of the ground when set of wheels are moved to the extended position; and
wherein the mobile enclosure and first enclosed grazing area are placed on or near the ground when set of wheels are moved to the retracted position.

2. The system of claim 1, wherein the frame includes an upper section and a lower section;
wherein the frame includes side support members connected the upper section to the lower section.

3. The system of claim 1, wherein the set of lift wheel assemblies includes:
a first lift wheel assembly operably connected to the front end of the frame;
a second lift wheel assembly operably connected to a left one of the opposing sides of the frame; and
a third lift wheel assembly operably connected to a right one of the opposing sides of the frame.

4. The system of claim 1, wherein the mobile enclosure is configured to operate in an operation mode and a transportation mode;
wherein when in the operation mode:
a first lift wheel assembly is operably connected to the front end of the frame;
a second lift wheel assembly operably connected to a left one of the opposing sides of the frame; and
a third lift wheel assembly operably connected to a right one of the opposing sides of the frame;
wherein when in the transportation mode:
the first lift wheel assembly is operably connected to one of the opposing sides of the frame;
the second lift wheel assembly operably connected to the front end of the frame; and
the third lift wheel assembly operably connected to the rear end of the frame.

5. The system of claim 1, wherein the set of lift wheel assemblies includes the set of wheels and a set of wheel suspensions;
wherein the set of wheel suspensions are configured to move the set of wheels between the extended position and retracted positions.

6. The system of claim 1, further comprising a second enclosed grazing area;
wherein the first enclosed grazing area is operably connected to the front end of the frame; and
wherein the second enclosed grazing area is operably connected to the rear end of the frame.

7. The system of claim 1, further comprising a second enclosed grazing area;
wherein the first enclosed grazing area is operably connected to the front end of the frame;
wherein the second enclosed grazing area is connected to the rear end of the frame by a hinged connection;
wherein the hinged connection permits a rear end of the second enclosed grazing area to remain on the ground when the mobile enclosure is lifted off of the ground by the lift wheel assemblies.

8. The system of claim 1, wherein the first enclosed grazing area includes a pair of side fences and a front fence;
wherein the pair of side fences each extend from a forward end to a rearward end;
wherein the rearward ends of the pair of side fences are connected to the front end of the frame;
wherein the front fence the front fence is connected to the forward ends of the side fences by a hinged connection; and
wherein the hinged connection is configured to permit a lower end of the front fence to swing upwards.

9. The system of claim 1, wherein the mobile enclosure includes a motor configured to move the mobile enclosure when the set of wheels are moved to the extended position.

10. The system of claim 1, wherein the frame includes an upper section and a lower section;
wherein the frame includes side support members connected the upper section to the lower section;
wherein the mobile enclosure includes a roof connected on top of the upper section of the frame;
wherein the mobile enclosure includes a solar panel;
wherein the mobile enclosure includes a power storage system configured to store energy generated by the solar panel; and
further comprising an electric motors configured to move the mobile enclosure when the set of wheels are moved to the extended position; and
wherein the electric motor is powered by the power storage system.

11. The system of claim 1, wherein the frame includes an upper section and a lower section;
wherein the frame includes side support members connected the upper section to the lower section;
wherein the mobile enclosure includes a roof connected on top of the upper section of the frame;
wherein the mobile enclosure includes walls connected to the side support members of the frame;
wherein the mobile enclosure includes a doorway permitting livestock to move between the mobile enclosure and the first enclosed grazing area.

12. The system of claim 1, wherein the mobile enclosure includes a plurality of separated stalls for livestock.

13. The system of claim 1, wherein the mobile enclosure includes an elevated floor;
wherein the elevated floor includes a plurality of holes configured to facilitate removal of manure through the holes for deposition on the ground below.

14. A portable livestock enclosure system, comprising:
a mobile enclosure;
the mobile enclosure including a frame;
wherein the frame has front end, a rear end, and opposing sides;
a enclosed grazing area connected to the frame of the mobile enclosure;
a set of lift wheel assemblies operably connected to the frame;
wherein the set of lift wheel assemblies are configured to move a set of wheels between a retracted position and an extended position;
wherein the mobile enclosure and enclosed grazing area are lifted off of the ground when the set of wheels are moved to the extended position;
wherein the mobile enclosure and enclosed grazing area are placed on or near the ground when set of wheels are moved to the retracted position;
a motor;
a control system;
wherein the control system is communicatively connected to the set of lift wheel assemblies and the motor;
wherein the control system is configured to move the mobile enclosure by: causing set of lift wheel assemblies to move the set of wheels to the extended position;
causing motor to move the mobile enclosure a distance in a field with the set of wheels in the extended position;
after moving the mobile enclosure the distance, causing set of lift wheel assemblies to move the set of wheels to the retracted position.

15. The system of claim 14, wherein the control system includes a GPS sensor;
wherein the control system is configured to causing motor to move the mobile enclosure using the GPS sensor to navigate.

16. The system of claim 14, wherein the moving of the mobile enclosure by the control system includes, in response to a movement scheduled in a movement schedule stored in a memory of the control system, accessing a predetermined navigation path or prescription plan stored in the memory to determine a path for movement of the mobile enclosure.

17. The system of claim 14, wherein the moving of the mobile enclosure by the control system includes, monitoring a sensor during movement of the mobile enclosure to detect when livestock are in close proximity to a fence of the enclosed grazing area; and
in response to detecting that the livestock are in close proximity to the fence of the enclosed grazing area, halting movement of the mobile enclosure.

18. The system of claim 14, further comprising a second enclosed grazing area connected to the frame of the mobile enclosure.

19. The system of claim 14, wherein the control system is configured to sent an alert to a user in response to signal from a sensor of the control system satisfying a trigger condition specified in a memory of the control system.

20. A method for farming row crops and grazing livestock in a field, the method comprising:
planting row crops in a first plurality of strips in the field;
planting forage crops in a second plurality of strips in the field;
wherein the first plurality of strips are separated by the second plurality of strips;
wherein the second plurality of strips are separated by the first plurality of strips;
providing a portable livestock enclosure system;
wherein the portable livestock enclosure system includes a mobile enclosure having one or more enclosed grazing areas;
while housing livestock in the portable livestock enclosure system, grazing at least some of the livestock on the foraging crops by moving the portable livestock enclosure system through one or more of the second plurality of strips; and
fertilizing the second plurality of strips by depositing manure from the livestock to the ground located beneath the portable livestock enclosure system.
